(19) United States
(12) Patent Application Publication
(10) Pub. No.: US 2021/0190678 A1
(43) Pub. Date: Jun. 24, 2021

(54) METHOD OF EVALUATING SURFACE STATE OF INSPECTION TARGET, EVALUATION DEVICE, METHOD OF CONTROLLING EVALUATION DEVICE, AND CONTROL PROGRAM OF EVALUATION DEVICE

(71) Applicant: Sintokogio, Ltd., Nagoya-shi, Aichi (JP)

(72) Inventors: Toshiya Tsuji, Toyokawa-shi, Aichi (JP); Shoichi Yamamoto, Toyokawa-shi, Aichi (JP); Yuji Kobayashi, Toyokawa-shi, Aichi (JP); Toshio Sugibayashi, Hachioji-shi, Tokyo (JP); Shun Yoshida, Hachioji-shi, Tokyo (JP)

(21) Appl. No.: 16/755,838

(22) PCT Filed: Oct. 25, 2018
(86) PCT No.: PCT/JP2018/039760

§ 371 Date: Apr. 13, 2020

(30) Foreign Application Priority Data
Nov. 14, 2017 (JP) 2017-219029

(51) Int. Cl. G01N 21/27; G01N 21/88; G01N 21/95; G01J 3/02

(52) U.S. Cl. CPC G01N 21/27; G01J 3/0278; G01N 21/9515; G01N 21/8806

(57) ABSTRACT

One point on a surface of a qualified article is measured in advance by a color sensor without contact, and a qualification reference value is set based on an output value thereof. Thereafter, one point on a surface of an inspection target of same design specifications as the qualified article is measured by the color sensor without contact, and an output value thereof is compared with the qualification reference value, and qualification/failure is judged. Because qualification/failure can be carried out without contacting an inspection target in this way, application to a high-speed production line is possible.

### TECHNICAL FIELD

The present disclosure relates to a method of evaluating a surface state of an inspection target, an evaluation device, a method of controlling an evaluation device, and a control program of an evaluation device.

### BACKGROUND ART

An invention relating to a method of determining a base processed state of a metal surface is disclosed in International Publication No. 2015/044591. In this invention, colorimetric analysis of a metal surface is carried out in order to determine the base processed state of the metal surface. A color measuring device is used in this colorimetric analysis, and the color measuring device is equipped with an end plug for blocking external light sources. Namely, colorimetric analysis using a color measuring device is carried out in a state in which the end plug is made to contact the metal surface that has been subjected to base processing.

### PRIOR ART DOCUMENTS

### Patent Documents

Patent Document 1: International Publication No. 2015/044591

### SUMMARY OF INVENTION

### Technical Problem

However, a structure that makes an end plug to contact a surface cannot be applied to a high-speed production line.

In view of the above-described circumstances, an object of the present disclosure is to provide a method of evaluating a surface state of an inspection target, an evaluation device, a method of controlling an evaluation device, and a control program of an evaluation device that can be applied to a high-speed production line.

### Solution to Problem

A method of evaluating a surface state of an inspection target relating to a first aspect of the present disclosure is a method by using a color sensor, which has a light projecting portion and a light receiving portion, the color sensor is configured such that light is illuminated from the light projecting portion, is reflected at a measurement target surface and is received at the light receiving portion. The color sensor computes an output value corresponding to a color of the measurement target from light intensities of red, blue and green that are received at the light receiving portion. The method includes: measuring, in advance and by the color sensor, one point on a surface of a qualified article without contacting the surface, and, based on an output value from the color sensor, a computer sets a qualification reference value. Thereafter, measuring, by the color sensor without contact, one point on a surface of an inspection target having the same design specifications as the qualified article. After the qualification reference value is set, the computer comparing the output value of the inspection target or a corrected value, with the qualification reference value, the output value of the inspection target is output from the color sensor, and the corrected value is obtained by correcting the output value of the inspection target in accordance with measuring conditions at a time of measurement by the color sensor and based on a predetermined criterion, and determining qualification or failure of the inspection target.

Note that “qualified article” means a product that has been determined to have been finished to a surface state that is a given reference or better (hereinafter, the same holds in the present specification). Further, in addition to specifications relating to the material and the dimensions of the inspection target, specifications relating to surface treatments that have been carried out on the inspection target also are included in the “design specifications” (hereinafter, the same holds in the present specification).

In accordance with the above-described structure, one point on the surface of a qualified article is measured in advance without contact by the color sensor, and a computer sets a qualification reference value based on the output value thereof. Thereafter, one point on the surface of an inspection target, which has the same design specifications as the qualified target, is measured without contact by the color sensor. The computer compares the output value, which is output from the color sensor after the qualification reference value has been set, or a corrected value, which is obtained by correcting the output value in accordance with measuring conditions at the time of the measuring thereof and based on a predetermined criterion, with the qualification reference value, and determines the qualification or failure. Because the qualification or failure can be determined without contacting the inspection target in this way, the processing time can be kept short, and application to a high-speed production line is possible.

In a second aspect of the present disclosure, in the method of the first aspect, before one point on the surface of the inspection target is measured by the color sensor, one point on the surface of the qualified article is measured by the color sensor in a plurality of patterns each having a different clearance, along a direction of a light illumination central axis of the light projecting portion, between the surface of the qualified article and a predetermined region, of the color sensor which faces a measurement target side, and clearance is measured by a distance measurement meter that is built into the color sensor. The computer computes a correction factor, which corresponds to the clearances, based on a relationship between output values from the distance measurement meter and output values relating to color from the color sensor, in the plural patterns. Thereafter, a clearance, along a direction of the light illumination central axis of the light projecting portion, between the surface of the inspection target and a predetermined region of the color sensor, which faces the measurement target side, the color sensor is disposed at a position for measuring the inspection target, is measured by the distance measurement meter without contacting the inspection target. The computer corrects an output value, which relates to the color at a time when one point on the surface of the inspection target is measured without contact by the color sensor, by the correction factor that corresponds to a value measured by the distance measurement meter after the correction factor is computed, compares the corrected value with the qualification reference value, and determines qualification or failure of the inspection target.

In accordance with the above-described structure, before one point on the surface of the inspection target is measured by the color sensor, one point on the surface of a qualified article is measured by the color sensor in plural patterns that vary the clearances, along the direction of the light illumination central axis of the light projecting portion, between the surface of the qualified article and a predetermined region of the color sensor, and the clearance is measured by a distance measurement meter that is built into the color sensor. The computer computes a correction factor, which corresponds to the respective clearances, based on the relationship between output values from the distance measurement meter and the output values relating to color by the color sensor, in the plural patterns. Thereafter, a clearance, along the direction of the light illumination central axis of the light projecting portion, between the surface of the inspection target and a predetermined region of the color sensor, which faces the measurement target side, the color sensor is disposed at a position for measuring the inspection target, is measured by the distance measurement meter without contacting the inspection target. The computer corrects the output value, which relates to the color at a time when one point on the surface of the inspection target is measured without contact by the color sensor, by the correction factor that corresponds to a value measured by the distance measurement meter after the correction factor is computed, and compares the corrected value with the qualification reference value, and determines qualification or failure of the inspection target. Due thereto, the qualification or failure can be determined accurately even if there is dispersion in the clearance between the light projecting portion of the color sensor and the measurement point on the surface of the inspection target.

In a third aspect of the present disclosure, in the method of the first aspect, before one point on the surface of the inspection target is measured by the color sensor, one point on the surface of the qualified article is measured by the color sensor in plural patterns each having different conditions, the conditions are a clearance along a direction of a light illumination central axis of the light projecting portion, between the surface of the qualified article and a predetermined region of the color sensor, which faces the measurement target side, and an inclination of the direction of the light illumination central axis of the light projecting portion with respect to a direction orthogonal to a measured portion of the surface of the qualified article, and the clearance is respectively measured by two distance measurement meters that are built into the color sensor at respective sides in a direction in which the light projecting portion and the light receiving portion are aligned. The computer computes the inclination and an average value of the clearances as first data from results of measurement by the two distance measurement meters, and computes in advance a correction factor that corresponds to the inclination and to the average clearance based on a relationship between the first data and output values relating to the color of the color sensor in the plural patterns, thereafter, clearances, along the direction of the light illumination central axis of the light projecting portion between the surface of the inspection target and a predetermined region of the color sensor, which faces the measurement target side, the color sensor is disposed at a position for measuring the inspection object, are respectively measured by the two distance measurement meters without contacting the inspection target, the computer computes an average value of the clearances and inclination of the direction of the light illumination central axis of the light projecting portion with respect to a direction orthogonal to a measured portion of the surface of the inspection target as second data from the two results of measurement, and the computer corrects an output value, which relates to the color at the time when one point on the surface of the inspection target is measured without contact by the color sensor, by the correction factor that corresponds to the second data, and compares the corrected value with the qualification reference value, and determines qualification or failure of the inspection target.

In accordance with the above-described aspect, before one point on the surface of the inspection target is measured by the color sensor, one point on the surface of a qualified article is measured by the color sensor in plural patterns that vary conditions. One of the conditions is the clearances, along the direction of the light illumination central axis of the light projecting portion between the surface of the qualified article and a predetermined region of the color sensor, which faces the measurement target side. The clearances are measured by two distance measurement meters that are built into the color sensor. Another of the conditions is the inclination of the direction of the light illumination central axis of the light projecting portion with respect to a direction orthogonal to the measured portion of the surface of the qualified article. Moreover, the computer computes the average value of the clearances from the results of measurement by the two distance measurement meters and the inclination as first data, and computes a correction factor that corresponds to the inclination and to the average clearance from the relationship between the first data and the output value relating to the color of the color sensor in the plural patterns. Thereafter, clearances, which run along the direction of the light illumination central axis of the light projecting portion, between the surface of the inspection target and a predetermined region, which faces the measurement target side, at the color sensor that is disposed at the position at the time of measuring the inspection target, are respectively measured by the two distance measurement meters without contacting the inspection target. Moreover, the computer computes, from the two results of the measurements, the average value of the clearances and the inclination of direction of the light illumination central axis of the light projecting portion with respect to a direction orthogonal to the measured portion of the surface of the inspection target as the second data. Further, the computer corrects the output value, which relates to the color at the time when one point on the surface of the inspection target was measured without contact by the color sensor, by the correction factor that corresponds to the second data, and compares the corrected value with the qualification reference value, and determines qualification or failure of the inspection target. Due thereto, qualification or failure can be determined accurately even if there is dispersion in both of or one of the clearance between the light projecting portion of the color sensor and the measurement point on the surface of the inspection target, and the inclination of the light illumination central axis direction of the light projecting portion.

In a fourth aspect of the present disclosure, in the method of the first aspect, one point on a surface of one qualified article having same design specifications as the inspection target is measured in advance by the color sensor, and the computer sets the output value of the one qualified article as the qualification reference value.

In accordance with the above-described structure, the qualification reference value can be set from one qualified article that has the same design specifications.

In a fifth aspect of the present disclosure, in the method of evaluating a surface state of an inspection target relating to any one of the first through third aspects, respective single points on surface of a plurality of qualified articles of same design specifications as the inspection target are measured in advance by the color sensor, and the computer sets a lowest output value among the output values of the plural qualified articles as the qualification reference value.

In accordance with the above-described structure, the qualification reference value can be set from plural qualified articles that have the same design specifications.

An evaluation device relating to a sixth aspect of the present disclosure, the evaluation device evaluates a surface state of an inspection target that is a product having specific design specifications, the evaluation device comprising: a color measurement section that has a light projecting portion that illuminates a measurement target surface, a light receiving portion that receives light from the light projecting portion and that is reflected by the measurement target surface, and a computing section that computes an output value corresponding to a color of a measurement target with light intensities of red, blue and green received at the light receiving portion, and the color measurement section does not contact the measurement target at a time of measurement; a mode selection unit that can select a first mode in a case of measuring a surface state of a qualified article having the specific design specifications, and a second mode in a case of determining a surface state of an inspection target; and a data processing section that has a qualification reference setting section, which sets a qualification reference value based on an output value output from the color measurement section in a state in which the first mode is selected, and a determination section that compares the output value or a corrected value with the qualification reference value, the output value is output from the color measurement section in a state in which the second mode is selected, and the corrected value is obtained by correcting the output value in accordance with measurement conditions at a time of measurement by the color measurement section and based on a predetermined criterion, and determines qualification or failure of the inspection target.

In accordance with the above-described structure, the evaluation device evaluates the surface state of a product, which has specific design specifications, as an inspection target and has a color measurement section, a mode selection unit, and a data processing section. The color measurement section does not contact the measurement target at the time of measurement, and receives, at the light receiving portion, light from the light projecting portion and reflected by the measurement target surface. The computing section computes an output value corresponding to the color of the measurement target from the light intensities of red, blue and green received at the light receiving portion. The mode selection unit can select a first mode, which is selected in a case of measuring the surface state of a qualified article having the specific design specifications, and a second mode, which is selected in a case of determining the surface state of an inspection target.

Here, the evaluation device of the present aspect has a data processing section that has a qualification reference setting section and a determination section. The qualification reference setting section sets a qualification reference value based on the output value output from the color measurement section in a state in which the first mode is selected. Further, the determination section compares the output value or a corrected value with the qualification reference value and determines qualification or failure of the inspection target. The output value is output from the color measurement section in a state in which the second mode is selected. The corrected value is obtained by correcting the output value in accordance with measurement conditions at the time of measurement and based on a predetermined criterion. Because the qualification or failure can be determined without contacting the inspection target in this way, the processing time can be kept short, and application of the present evaluation device to a high-speed production line is possible.

In a seventh aspect of the present disclosure, the evaluation device of the sixth aspect comprises a distance measurement portion that is integrated with the color measurement section and structures a measurement instrument, and the distance measurement portion measures, without contacting the measurement target, a clearance along a direction of a light illumination central axis of the light projecting portion, between the measurement target and a predetermined region of the measurement instrument, which faces a measurement target side. The data processing section has a correction factor computing section that computes a correction factor in accordance with the clearance based on a relationship between an output value that is output from the color measurement section in a state in which the first mode is selected, and an output value that is output from the distance measurement portion in a state in which the first mode is selected, the output value of the color measurement section and the output value of the distance measurement portion are stored in association with one another. The determination section corrects the output value that is output from the color measurement section in a state in which the second mode is selected, by the correction factor, which corresponds to an output value output from the distance measurement portion in a state in which the second mode is selected, and compares the corrected value with the qualification reference value, and determines qualification or failure of the inspection target.

In accordance with the above-described structure, the distance measurement portion is integrated with the color measurement section and structures the measurement instrument, and measures, without contacting the measurement target, the clearance, along the direction of the light illumination central axis of the light projecting portion, between the measurement target and a predetermined region of the measurement instrument, which faces the measurement target side. Further, the data processing section has the correction factor computing section. The correction factor computing section computes a correction factor corresponding to the clearance based on the relationship between an output value, which is output from the color measurement section in a state in which the first mode is selected, and an output value, which is output from the distance measurement portion in a state in which the first mode is selected. The output value output by the color measurement section and the output value output by the distance measurement portion are stored in association with one another. Further, the determination section corrects an output value, which is output from the color measurement section in a state in which the second mode is selected, by the correction factor that corresponds to an output value output from the distance measurement portion in a state in which the second mode is selected, and compares the corrected value with the qualification reference value, and determines qualification or failure of the inspection target. Due thereto, the qualification or failure can be determined accurately even if there is dispersion in the clearance between the light projecting portion of the color measurement portion and the measurement target.

In an eighth aspect of the present disclosure, the evaluation device of the sixth aspect comprises: two distance measurement portions that are disposed at respective sides, in a direction in which the light projecting portion and the light receiving portion are aligned at the color measurement section, the two distance measurement portions are integrated with the color measurement section and structure a measurement instrument, and the two distance measurement portions respectively measure, without contacting the measurement target, clearances along a direction of a light illumination central axis of the light projecting portion, between the measurement target and a predetermined region of the measurement instrument, which faces the measurement target side. The data processing section has: a distance inclination computing section that, based on output values respectively output from the two distance measurement portions, computes an average value of the clearances, and computes an inclination of the direction of the light illumination central axis of the light projecting portion with respect to a direction orthogonal to the measurement target surface; and a correction factor computing section that computes a correction factor that corresponds to the inclination and to the average clearance based on a relationship between the output value, which is output from the color measurement section in a state in which the first mode is selected, and the computed value, which is computed by the distance inclination computing section based on output values respectively output from the two distance measurement portions in a state in which the first mode is selected, the output value output from the color measurement section and the computed value computed by the distance inclination computing section are stored in association with one another. The determination section corrects an output value, which is output from the color measurement section in a state in which the second mode is selected, by the correction factor that corresponds to a computed value computed by the distance inclination computing section based on output values that are respectively output from the two distance measurement portions in a state in which the second mode is selected, and compares the corrected value with the qualification reference value, and determines qualification or failure of the inspection target.

In accordance with the above-described structure, the two distance measurement portions are disposed at respective sides, in the direction in which the light projecting portion and the light receiving portion are aligned, at the color measurement section, and are integrated with the color measurement section and structure a measurement instrument, and respectively measure, without contacting the measurement target, clearances along the direction of the light illumination central axis of the light projecting portion, between the measurement target and a predetermined region of the measurement instrument, which faces the measurement target side. The data processing section has a distance inclination computing section and a correction factor computing section. From the output values respectively output from the two distance measurement portions, the distance inclination computing section computes the average value of the clearances, and computes the inclination of the direction of the light illumination central axis of the light projecting portion with respect to a direction orthogonal to the measurement target surface. The correction factor computing section computes a correction factor that corresponds to the inclination and to the average clearance based on the relationship between the output value, which is output from the color measurement section in a state in which the first mode is selected, and a computed value, which is computed by the distance inclination computing section based on the output values respectively output from the two distance measurement portions in a state in which the first mode is selected. The output value output from the color measurement section and the computed value computed by the distance inclination computing section are stored in association with one another. Further, the determination section corrects the output value, which is output from the color measurement section in a state in which the second mode is selected, by the correction factor that corresponds to a computed value computed by the distance inclination computing section based on output values that are respectively output from the two distance measurement portions in a state in which the second mode is selected, and compares the corrected value with the qualification reference value, and determines qualification or failure of the inspection target. Due thereto, qualification or failure can be determined accurately even if there is dispersion in both of or one of the clearance between the light projecting portion of the color measurement section and the measurement target, and the inclination of the direction of the light illumination central axis of the light projecting portion.

In a ninth aspect of the present disclosure, in the evaluation device relating to any one of the sixth aspect through the eighth aspect, in a case in which data of an output value output from the color measurement section in a state in which the first mode is selected is a single item of data, the qualification reference setting section sets the output value to be the qualification reference value.

In accordance with the above-described structure, the qualification reference value can be set from the single qualified article.

In a tenth aspect of the present disclosure, in the evaluation device relating to any one of the sixth aspect through the ninth aspect, in a case in which data of an output value output from the color measurement section in a state in which the first mode is selected is plural items of data, the qualification reference setting section sets a lowest value of the output values to be the qualification reference value.

In accordance with the above-described structure, the qualification reference value can be set from plural qualified articles.

An evaluation device relating to an eleventh aspect of the present disclosure includes: a color measurement section that has a light projecting portion that illuminates a measurement target surface, a light receiving portion that receives light from the light projecting portion and reflected by the measurement target surface, and a computing section that computes an output value corresponding to a color of a measurement target from light intensities of red, blue and green received at the light receiving portion, and the color measurement section does not contact the measurement target at a time of measurement; an information input portion inputs information related to design specifications of a measurement target; a mode selection unit selects a first mode in a case of measuring a surface state of a qualified article, and a second mode in a case of determining a surface state of an inspection target; and a data processing section that has a qualification reference setting section, which sets a qualification reference value for each design specification of the measurement target based on information from the information input portion and an output value output from the color measurement section in a state in which the first mode is selected, and a determination section that compares an output value or a corrected value with the qualification reference value for a product having same design specifications as the measurement target, the output value is output from the color measurement section in a state in which the second mode is selected, the corrected value is obtained by correcting the output value in accordance with measurement conditions at a time of measurement of the measurement target and based on a predetermined criterion, and determines qualification or failure of the inspection target.

In accordance with the above-described structure, the color measurement section does not contact the measurement target at the time of measurement, and receives, at the light receiving portion, light from the light projecting portion and reflected by the measurement target surface. The computing section computes an output value corresponding to the color of the measurement target from the light intensities of red, blue and green received at the light receiving portion. At the information input portion, information of the design specifications of a measurement target can be inputted. At the mode selection unit, a first mode, which is selected in a case of measuring the surface state of a qualified article, and a second mode, which is selected in a case of determining the surface state of an inspection target, can be selected.

The evaluation device of the present aspect has a data processing section that has a qualification reference setting section and a determination section. The qualification reference setting section sets a qualification reference value for each design specification of the measurement target based on information from the information input portion and the output value output from the color measurement section in a state in which the first mode is selected. The determination section compares an output value or a corrected value with the qualification reference value for a product having the same design specifications as the measurement target, and determines qualification or failure of the inspection target. The output value is output from the color measurement section in a state in which the second mode is selected, and the corrected value is obtained by correcting the output value in accordance with measurement conditions at the time of measurement in the second mode and based on a predetermined criterion. Because the qualification or failure can be determined without contacting the inspection target in this way, the processing time can be kept short, and application of the evaluation device to a high-speed production line is possible.

In a twelfth aspect of the present disclosure, the evaluation device of the eleventh aspect includes a distance measurement portion that is integrated with the color measurement section and structures a measurement instrument, and that measures, without contacting the measurement target, a clearance along a direction of a light illumination central axis of the light projecting portion, between the measurement target and a predetermined region of the measurement instrument, which faces the measurement target side. The data processing section has a correction factor computing section that computes a correction factor, which corresponds to a clearance for each design specification of the measurement target, based on information from the information input portion and a relationship between an output value that is output from the color measurement section in a state in which the first mode is selected, and an output value that is output from the distance measurement portion in a state in which the first mode is selected. The output value output from the color measurement section and the output value output from the distance measurement portion are stored in association with one another. The determination section corrects an output value that is output from the color measurement section in a state in which the second mode is selected, by the correction factor, which corresponds to an output value that is output from the distance measurement portion in a state in which the second mode is selected, and to the information of design specifications of the measurement target, and compares the corrected value with the qualification reference value for a qualified product having the same design specifications as the measurement target, and determines qualification or failure of the inspection target.

In accordance with the above-described structure, the distance measurement portion is integrated with the color measurement section and structures a measurement instrument, and measures, without contacting the measurement target, the clearance along the direction the light illumination central axis of the light projecting portion, between the measurement target and a predetermined region at the measurement instrument, which faces the measurement target side. The data processing section has a correction factor computing section. The correction factor computing section computes a correction factor corresponding to the clearance for each design specification of the measurement target, based on information from the information input portion and the relationship between the output value that is output from the color measurement section in a state in which the first mode is selected, and the output value that is output from the distance measurement portion in a state in which the first mode is selected. Further, the determination section corrects the output value that is output from the color measurement section in a state in which the second mode is selected, by the correction factor that corresponds to the output value that is output from the distance measurement portion in a state in which the second mode is selected, and to the information of the design specifications of the measurement target, and compares the corrected value with the qualification reference value for a qualified product having the same design specifications as the measurement target, and determines qualification or failure of the inspection target. Due thereto, the qualification or failure can be determined accurately even if there is dispersion in the clearance between the light projecting portion of the color measurement section and the measurement target.

In a thirteenth aspect of the present disclosure, the evaluation device relating to the eleventh aspect includes two distance measurement portions that are disposed at respective sides of the color measurement section in a direction in which the light projecting portion and the light receiving portion are aligned, and that are integrated with the color measurement section and structure a measurement instrument, and that respectively measure, without contacting the measurement target, clearances along a direction of a light illumination central axis of the light projecting portion, between the measurement target and a predetermined region of the measurement instrument, which faces the measurement target side. The data processing section has: a distance inclination computing section that, based on output values respectively output from the two distance measurement portions, computes an average value of the clearances, and computes an inclination of the direction of the light illumination central axis of the light projecting portion with respect to a direction orthogonal to the measurement target surface; and a correction factor computing section that computes a correction factor that corresponds to the inclination and to an average clearance of the clearance for each design specification of the measurement target, based on information from the information input portion and a relationship between an output value that is output from the color measurement section in a state in which the first mode is selected, and a computed value that is computed by the distance inclination computing section based on output values that are respectively output from the two distance measurement portions in a state in which the first mode is selected. The output value output from the color measurement section and the computed value computed from the distance inclination computing section are stored in association with one another The determination section corrects an output value that is output from the color measurement section in a state in which the second mode is selected, by the correction factor, which corresponds to the information of the design specifications of the measurement target and to a computed value computed by the distance inclination computing section based on output values that are respectively output from the two distance measurement portions in a state in which the second mode is selected, and compares the corrected value with the qualification reference value for a qualified product having the same design specifications as the measurement target, and determines qualification or failure of the inspection target.

In accordance with the above-described structure, the two distance measurement portions are disposed at respective sides, in the direction in which the light projecting portion and the light receiving portion are aligned at the color measurement section, and are integrated with the color measurement section and structure a measurement instrument, and respectively measure, without contacting the measurement target, clearances along the direction of the light illumination central axis of the light projecting portion, between the measurement target and a predetermined region of the measurement instrument, which faces the measurement target side. The data processing section has a distance inclination computing section and a correction factor computing section. From the output values that are respectively output from the two distance measurement portions, the distance inclination computing section computes the average value of the clearances, and computes the inclination of the direction of the light illumination central axis of the light projecting portion with respect to a direction orthogonal to the measurement target surface. The correction factor computing section computes a correction factor that corresponds to the inclination and to an average clearance of the clearance for each design specification of the measurement target, based on information from the information input portion and the relationship between the output value that is output from the color measurement section in a state in which the first mode is selected, and a computed value that the distance inclination computing section computes based on output values that are respectively output from the two distance measurement portions in a state in which the first mode is selected. The output value output from the color measurement section and the computed value computed from the distance inclination computing section are stored in association with one another. Further, the determination section corrects the output value that is output from the color measurement section in a state in which the second mode is selected, by the correction factor that corresponds to the information of the design specifications of the measurement target and a computed value computed by the distance inclination computing section based on output values that are respectively output from the two distance measurement portions in a state in which the second mode is selected, and compares the corrected value with the qualification reference value for a qualified product having the same design specifications as the measurement target, and determines qualification or failure of the inspection target. Due thereto, qualification or failure can be determined accurately even if there is dispersion in both of or one of the clearance between the light projecting portion of the color measurement section and the measurement target, and the inclination of the direction of the light illumination central axis of the light projecting portion.

In a fourteenth aspect of the present disclosure, in the evaluation device relating to any one of the eleventh aspect through the thirteenth aspect, in a case in which data of an output value output from the color measurement section in a state in which the first mode is selected is a single item of data within a per-design-specification category that has been classified based on the information of design specifications of the measurement target, the qualification reference setting section sets the output value as the qualification reference value for a product having the design specifications.

In accordance with the above-described structure, the qualification reference value can be set from one qualified article within the per-design-specification category.

In a fifteenth aspect of the present disclosure, in the evaluation device relating to any one of the eleventh aspect through the fourteenth aspect, in a case in which data of an output value output from the color measurement section in a state in which the first mode is selected is plural items of data within a per-design-specification category that has been classified based on the information on the design specifications of the measurement target, the qualification reference setting section sets a lowest value of the output values as the qualification reference value for a product having the design specifications.

In accordance with the above-described structure, the qualification reference value can be set from plural qualified articles within the per-design-specification category.

In a sixteenth aspect of the present disclosure, in the evaluation device relating to any one of the eleventh aspect through the fifteenth aspect, the data processing section stores the input information, which specifies the design specifications of qualified article and which is used in setting the qualification reference values, and the qualification reference values, which is set by the qualification reference setting section, in a table in association with one another, and the determination section determines qualification or failure with reference to the table.

In accordance with the above-described structure, because the determination section determines qualification or failure while referring to a table in which qualification reference values and input information specifying the design specifications are stored in association with one another, the judgment on qualification or failure can be carried out efficiently.

A seventeenth aspect of the present disclosure is a method of controlling an evaluation device that evaluates a surface state of an inspection target that is a product having specific design specifications, the evaluation device having: a color measurement section that has a light projecting portion that illuminates a measurement target surface, a light receiving portion that receives light from the light projecting portion and that is reflected by the measurement target surface, and a computing section that computes an output value corresponding to a color of a measurement target from light intensities of red, blue and green received at the light receiving portion, and the color measurement section does not contact the measurement target at a time of measurement; and a mode selection unit that selects a first mode in a case of measuring a surface state of a qualified article having the specific design specifications, and a second mode in a case of determining a surface state of an inspection target. The method includes: in a case in which the first mode is selected, setting a qualification reference value based on an output value that is output from the color measurement section; and in a case in which the second mode is selected, comparing an output value or a corrected value with the qualification reference value, the output value is output from the color measurement section in a state in which the second mode is selected, the corrected value is obtained by correcting the output value in accordance with measurement conditions at a time of measurement in the second mode and based on a predetermined criterion, and determining qualification or failure of the inspection target. Therefore, in the same way as in the sixth aspect of the present disclosure, because the qualification or failure can be determined without contacting the inspection target, application of the method to a high-speed production line is possible.

An eighteenth aspect of the present disclosure is a method of controlling an evaluation device, the evaluating devise includes: a color measurement section having a light projecting portion that illuminates a measurement target surface, a light receiving portion that receives light from the light projecting portion and that is reflected by the measurement target surface, and a computing section that computes an output value corresponding to a color of a measurement target from light intensities of red, blue and green received at the light receiving portion, and the color measurement section does not contact the measurement target at a time of measurement; an information input portion inputs information relating to design specifications of the measurement target; and a mode selection unit that selects a first mod in a case of measuring a surface state of a qualified article, and a second mode in a case of determining a surface state of an inspection target. The method includes: in a case in which the first mode is selected, setting a qualification reference value for each design specification of the measurement target based on an output value that is output from the color measurement section and the information from the information input portion; and in a case in which the second mode is selected, comparing an output value or a corrected value with the qualification reference value for a product having the same design specifications as the measurement target, The output value is output from the color measurement section in a state in which the second mode is selected, the corrected value is obtained by correcting the output value in accordance with measurement conditions at a time of measurement in the second mode and based on a predetermined criterion, and determining qualification or failure of the inspection target. Therefore, in the same way as in the eleventh aspect of the present disclosure, because qualification or failure can be determined without contacting the inspection target, application of the method of controlling the evaluation device to a high-speed production line is possible.

A nineteenth aspect of the present disclosure is a control program for an evaluation device that evaluates a surface state of an inspection target that is a product having the specific design specifications, and the evaluation device includes: a color measurement section having a light projecting portion that illuminates a measurement target surface, a light receiving portion that receives light from the light projecting portion and that is reflected by the measurement target surface, and a computing section that computes an output value corresponding to a color of a measurement target from light intensities of red, blue and green received at the light receiving portion, and the color measurement section does not contact the measurement target at a time of measurement; and a mode selection unit that selects a first mode in a case of measuring a surface state of a qualified article having the specific design specifications, and a second mod in a case of determining a surface state of an inspection target. The control program causes a computer included in the evaluation device to execute processing including: in a case in which the first mode is selected, setting a qualification reference value based on an output value that is output from the color measurement section, and, in a case in which the second mode is selected, comparing an output value or a corrected value with the qualification reference value, the output value is output from the color measurement section in a state in which the second mode is selected, the corrected value is obtained by correcting the output value in accordance with measurement conditions at a time of measurement in the second mode and based on a predetermined criterion, and determining qualification or failure of the inspection target. Therefore, due to a computer executing the control program of an evaluation device relating to the nineteenth aspect of the present disclosure, the method of controlling an evaluation device relating to the seventeenth aspect of the present disclosure is implemented by a computer. Namely, in the same way as in the sixth aspect of the present disclosure and the seventeenth aspect of the present disclosure, because qualification or failure can be determined without contacting the inspection target, application of the control program to a high-speed production line is possible.

A twentieth aspect of the present disclosure is a control program for an evaluation device having: a color measurement section having a light projecting portion that illuminates a measurement target surface, a light receiving portion that receives light from the light projecting portion and that is reflected by the measurement target surface, and a computing section that computes an output value corresponding to a color of a measurement target from light intensities of red, blue and green received at the light receiving portion, and the color measurement section does not contact the measurement target at a time of measurement; an information input portion that input information related to design specifications of the measurement target; and a mode selection unit that selects a first mode in a case of measuring a surface state of a qualified article, and a second mode in a case of determining a surface state of an inspection target. The control program causes a computer included in the evaluation device to execute processing including: in a case in which the first mode is selected, setting a qualification reference value for each design specification of the measurement target based on an output value that is output from the color measurement section and the information from the information input portion, and, in a case in which the second mode is selected, comparing an output value or a corrected value with the qualification reference value for a product having the same design specifications as the measurement target, the output value is output from the color measurement section in a state in which the second mode is selected, the corrected value is obtained by correcting the output value in accordance with measurement conditions at a time of measurement in the second mode and based on a predetermined criterion, and determining qualification or failure of the inspection target. Therefore, due to a computer executing the control program of an evaluation device relating to the twentieth aspect of the present disclosure, the method of controlling an evaluation device relating to the eighteenth aspect of the present disclosure is implemented by a computer. Namely, in the same way as in the eleventh aspect of the present disclosure and the eighteenth aspect of the present disclosure, because qualification or failure can be determined without contacting the inspection target, application of the control program to a high-speed production line is possible.

### Advantageous Effects of Invention

As described above, in accordance with the present disclosure, there is the excellent effect that application to a high-speed production line is possible.

### BRIEF DESCRIPTION OF DRAWINGS

FIG. 1 is a block drawing showing the schematic structure of an evaluation device relating to a first embodiment of the present disclosure.

FIG. 2 is a block drawing showing the schematic structure of a data processing control device of the evaluation device relating to the first embodiment of the present disclosure.

FIG. 3A is a schematic vertical sectional view showing the schematic structure of a color sensor (color measurement section) in a state of being viewed from a lateral side, and shows a case in which there are indentations on the surface of a measurement target.

FIG. 3B is a schematic vertical sectional view showing the schematic structure of the color sensor (color measurement section) in a state of being viewed from a lateral side, and shows a case in which the surface of the measurement target is flat.

FIG. 4 is a flowchart showing an example of the flow of control processing executed by a data processing section of FIG. 1.

FIG. 5 is a side view schematically showing a state in which an inspection target is being subjected to a surface treatment in a stage before evaluation.

FIG. 6A is a graph showing test results.

FIG. 6B is a graph showing test results.

FIG. 7 is a block drawing showing the schematic structure of an evaluation device relating to a second embodiment of the present disclosure.

FIG. 8 is a block drawing showing the schematic structure of a data processing control device of the evaluation device relating to the second embodiment of the present disclosure.

FIG. 9 is a flowchart showing an example of the flow of control processing executed by a data processing section of FIG. 7.

FIG. 10 is a block drawing showing the schematic structure of an evaluation device relating to a third embodiment of the present disclosure.

FIG. 11 is a block drawing showing the schematic structure of a data processing control device of the evaluation device relating to the third embodiment of the present disclosure.

FIG. 12 is a schematic vertical sectional view showing a structure in which a distance measurement portion is built into a color sensor (color measurement section), in a state of being viewed from a lateral side.

FIG. 13 is a flowchart showing an example of the flow of control processing executed by a data processing section of FIG. 10.

FIG. 14 is a block drawing showing the schematic structure of an evaluation device relating to a fourth embodiment of the present disclosure.

FIG. 15 is a block drawing showing the schematic structure of a data processing control device of the evaluation device relating to the fourth embodiment of the present disclosure.

FIG. 16 is a flowchart showing an example of the flow of control processing executed by a data processing section of FIG. 14.

FIG. 17 is a block drawing showing the schematic structure of an evaluation device relating to a fifth embodiment of the present disclosure.

FIG. 18 is a block drawing showing the schematic structure of a data processing control device of the evaluation device relating to the fifth embodiment of the present disclosure.

FIG. 19 is a schematic vertical sectional view showing a structure in which a first distance measurement portion and a second distance measurement portion are built into a color sensor (color measurement section), in a state of being viewed from a lateral side.

FIG. 20 is a flowchart showing an example of the flow of control processing executed by a data processing section of FIG. 17.

FIG. 21 is a block drawing showing the schematic structure of an evaluation device relating to a sixth embodiment of the present disclosure.

FIG. 22 is a block drawing showing the schematic structure of a data processing control device of the evaluation device relating to the sixth embodiment of the present disclosure.

FIG. 23 is a flowchart showing an example of the flow of control processing executed by a data processing section of FIG. 21.

### DESCRIPTION OF EMBODIMENTS

### First Embodiment

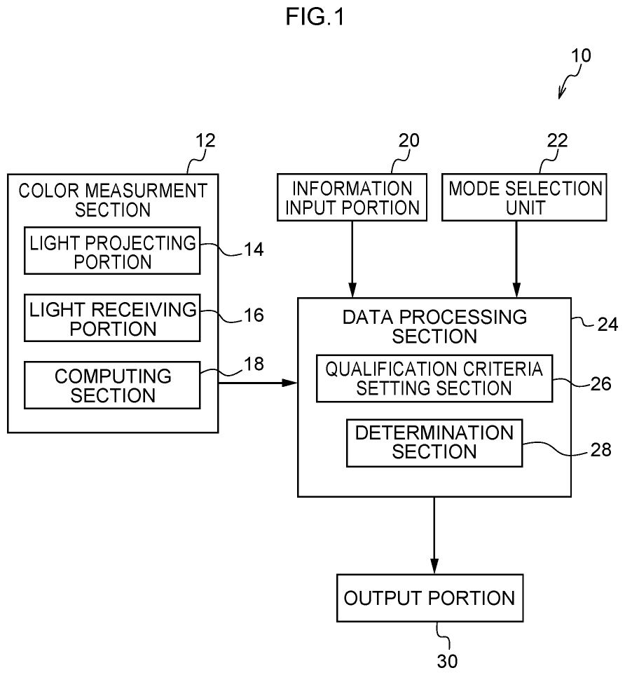

A method of evaluating a surface state of an inspection target, an evaluation device, a method of controlling an evaluation device, and a control program of an evaluation device relating to a first embodiment of the present disclosure are described by using FIG. 1 through FIG. 6B. Note that the method of evaluating a surface state of an inspection target, the evaluation device, the method of controlling an evaluation device, and the control program of an evaluation device relating to the present embodiment are, as an example, used in order to determine whether or not the removal of rust or scale has been carried out well at the surface of an inspection target that has been shot blasted in order to remove rust or scale.

The schematic structure of an evaluation device 10 of the present embodiment is shown in a block drawing in FIG. 1. As shown in FIG. 1, the evaluation device 10 includes a color measurement section 12, an information input portion 20, a mode selection unit 22, a data processing section 24 and an output portion 30.

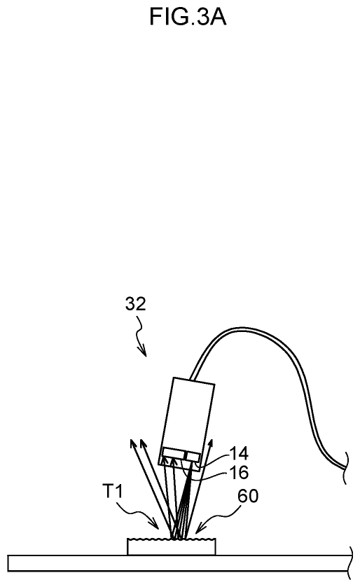

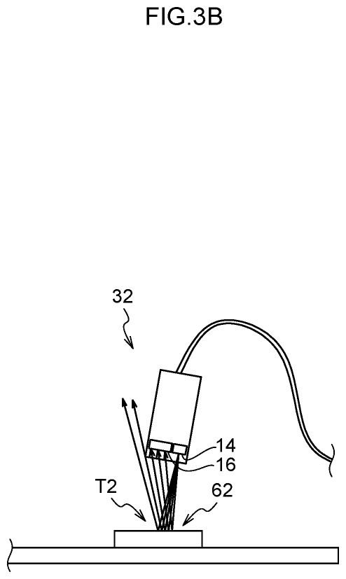

The color measurement section 12 carries out the processing of color measurement by a color sensor 32 (see FIG. 3A and FIG. 3B). The schematic structure of the color sensor 32 is shown in FIG. 3A and FIG. 3B in vertical sectional views when viewed from a lateral side. Note that a sensor of a structure similar to that of, for example, the E3NX-CA manufactured by Omron Corporation can be used for the color sensor 32.

As shown in FIG. 1, the color measurement section 12 has a light projecting portion 14, a light receiving portion 16, and a computing section 18. As shown in FIG. 3A and FIG. 3B, the light projecting portion 14 is a functional portion that illuminates a measurement target surface 60, 62, and light is reflected at the measurement target surface 60, 62. Further, the light receiving portion 16 is a functional portion that receives the light from the light projecting portion 14 and reflected by the measurement target surface 60, 62. Note that FIG. 3A illustrates a case in which there are indentations on a surface (the measurement target surface 60) of measurement target T1, and FIG. 3B illustrates a case in which a surface (the measurement target surface 62) of measurement target T2 is flat. The color measurement section 12 (see FIG. 1) does not contact the measurement targets T1, T2 at the time of measuring. The computing section 18 shown in FIG. 1 is a functional section that computes an output value, which corresponds to the color of the measurement target, from the light intensities of red, blue and green received at the light receiving portion 16. The color measurement section 12 is connected to the data processing section 24.

The information input portion 20, the mode selection unit 22 and the output portion 30 are connected to the data processing section 24. The information input portion 20 includes an input portion such as for example, a mouse and a keyboard, a touch screen, or the like. At the information input portion 20, a user can input information of the design specifications of the measurement target into, for example, input columns of a predetermined input screen by using the input portion. As an example, the information input portion 20 has a data copy function (a function of copying data that has already been inputted). Note that, in addition to specifications relating to the material and dimensions of the target article, specifications relating to the surface treatment that has been carried out on the target article also are included in the “design specifications”. Regarding articles that have been surface treated by shot blast processing, the specifications relating to the surface treatment include a type of the blasted material, a particle diameter of the blasted material, an amount of the blasted material per unit time, a blasting time of the blasted material, a blasting speed of the blasted material, an air pressure in a case in which the blasted material is jetted-out by air, a rotational speed per unit time of an impeller in a case in which the blasted material is accelerated by centrifugal force by the rotation of the impeller and is blasted, and a distance between the target that is surface treated and a blasting opening of the blasting machine.

Further, a first mode that is selected in a case in which the surface state of a qualified article is measured, and a second mode that is selected in a case of determining the surface state of an inspection target, can be selected at the mode selection unit 22. For the evaluation device 10, it is supposed that the second mode is selected at the mode selection unit 22, after the first mode is selected and the surface state of a qualified article is measured. Note that “qualified article” is, as an example, determined by an expert to have been finished to a surface state that is a given standard or better. The mode selection unit 22 is, as an example, a switch for mode selection that a user can operate. Note that, as a modified example, the mode selection unit 22 may be a button or an input portion for mode selection that a user can operate. The output portion 30 includes a display or the like for example, and can display and output the results of the processing of the data processing section 24.

The data processing section 24 has a qualification reference setting section 26 and a determination section 28. The qualification reference setting section 26 is a functional section that, based on the output value output from the color measurement section 12 in a state in which the first mode is selected and information from the information input portion 20, sets a qualification reference value for each design specification of the measurement target. Further, the determination section 28 is a functional section that compares an output value, which is output from the color measurement section 12 in the state in which the second mode is selected, with a qualification reference value for a product of the same design specifications as that of the measurement target, and determines qualification or failure of the inspection target.

In a case in which the data of the output value, which is output from the color measurement section 12 when the first mode is selected, is one data within a per-design-specification category that has been classified by information on the design specifications of the measurement target, the qualification reference setting section 26 sets that output value as the qualification reference value for a product of those design specifications. Further, in a case in which the data of the output value, which is output from the color measurement section 12 in the state in which the first mode is selected, is plural data within a per-design-specification category that has been classified by information on the design specifications of the measurement target, the qualification reference setting section 26 sets the lowest value of these output values as the qualification reference value for a product of those design specifications.

In the present embodiment, the data processing section 24 stores input information, which specifies the design specifications of products and which is used in setting qualification reference values, and qualification reference values, which have been set by the qualification reference setting section 26, in a table in association with one another, and the determination section 28 determines qualification or failure by referring to this table.

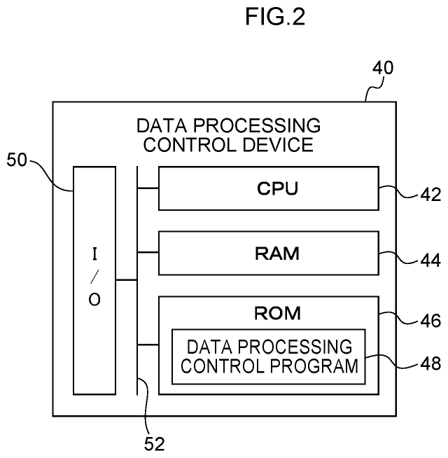

The data processing section 24 carries out data processing control for qualification or failure judgment by a data processing control device 40 that serves as a computer and is shown in FIG. 2. The schematic structure of the data processing control device 40 is shown in a block drawing in FIG. 2. The data processing control device 40 has a CPU 42, a RAM 44, a ROM 46 and an input/output interface section (I/O) 50, and these are connected to one another via a bus 52. The ROM 46 is a non-volatile storage, and a data processing control program 48 (an example of the control program of an evaluation device relating to the twentieth aspect of the present disclosure) is stored in the ROM 46. The I/O 50 carries out communication with devices at the exterior. The color sensor 32 (see FIG. 3A and FIG. 3B) is connected to the I/O 50. The data processing control device 40 functions as the data processing section 24 (see FIG. 1) due to the data processing control program 48 being read-out from the ROM 46 and being expanded in the RAM 44, and the data processing control program 48 that is expanded in the RAM 44 being executed by the CPU 42.

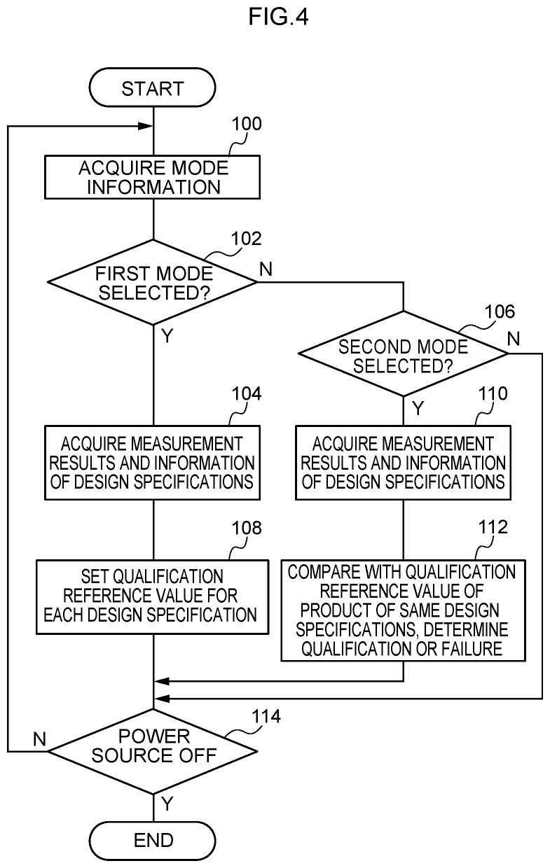

Next, an example of the flow of control processing (the control method of the evaluation device 10), which is executed at the data processing section 24 (the data processing control device 40 (see FIG. 2)) at the evaluation device 10 shown in FIG. 1, is described as the operation of the present embodiment and with reference to the flowchart shown in FIG. 4. In the present embodiment, as an example, when the power source of the data processing control device 40 shown in FIG. 2 is turned on, execution of the control processing shown in FIG. 4 is started.

In step 100 of the control processing shown in FIG. 4, the data processing section 24 acquires the mode information that is selected at the mode selection unit 22.

In step 102 after step 100, based on the mode information acquired in previous step 100, the data processing section 24 determines whether or not the first mode is selected. If the judgment of step 102 is negative, the routine moves on to step 106, and, if the judgment of step 102 is affirmative, the routine moves on to step 104.

In step 104, the data processing section 24 acquires the output values that are the results of measurement from the color measurement section 12, and acquires information of the design specifications of the measurement target that was inputted at the information input portion 20. In step 108 after step 104, based on the output values, which are output from the color measurement section 12 in the state in which the first mode is selected, and the information from the information input portion 20, the data processing section 24 sets a qualification reference value for each design specification of the measurement target. The routine moves on to step 114 t after step 108. Step 114 is described later.

On the other hand, in step 106, based on the mode information acquired in step 100, the data processing section 24 determines whether or not the second mode is selected. If the judgment in step 106 is negative, the routine moves on to step 114, and, if the judgment in step 106 is affirmative, the routine moves on to step 110.

In step 110, the data processing section 24 acquires the output value that is the result of measurement from the color measurement section 12, and acquires information of the design specifications of the measurement target that was inputted at the information input portion 20. In step 112 after step 110, the data processing section 24 compares the output value output from the color measurement section 12 in the state in which the second mode is selected, with the qualification reference value for a product of the same design specifications as the measurement target, and determines qualification or failure. Here, at the data processing section 24, the determination section 28 determines the qualification or failure by referring to a table in which the input information that specify design specifications and the qualification reference values are stored in association with one another. Therefore, the determination on qualification or failure can be carried out efficiently. The routine moves on to step 114 after step 112.

In step 114, the data processing section 24 determines whether or not the power source of the data processing control device 40 (see FIG. 2) has been turned off. If the judgment in step 114 is negative, the routine returns to step 100, and step 100 through step 114 are repeated until the judgment of step 114 is affirmative. When the judgment of step 1114 is affirmative, the control processing shown in FIG. 4 ends.

The method of evaluating a surface state of an inspection target by using the color sensor 32 shown in FIG. 3A and FIG. 3B and the data processing control device 40 shown in FIG. 2 is described next.

In the method of evaluating a surface state of an inspection target, one point on the surface of a qualified article is measured in advance without contact by the color sensor 32 shown in FIG. 3A and FIG. 3B, and, based on the output value thereof, the data processing control device 40 (see FIG. 2) sets a qualification reference value. Thereafter, one point on the surface of an inspection target, which has the same design specification as that of the qualified article, is measured without contact by the color sensor 32, and the data processing control device 40 compares the output value with the qualification reference value, and determines the qualification/failure. Concretely, if the output value of the color sensor 32 is greater than or equal to the qualification reference value, the data processing control device 40 determines that the article has qualified, and, if the output value of the color sensor 32 is less than the qualification reference value, the data processing control device 40 determines that the article has failed.

In the method of evaluating a surface state of an inspection target, one point on the surface of one qualified article that has the same design specifications as the inspection target may be measured in advance by the color sensor 32, and the output value thereof may be set to be the qualification reference value. Or, respective single points on the surfaces of plural qualified articles of the same design specifications as the inspection target may be measured in advance by the color sensor 32, and the output value that is the lowest among these output values may be set to be the qualification reference value.

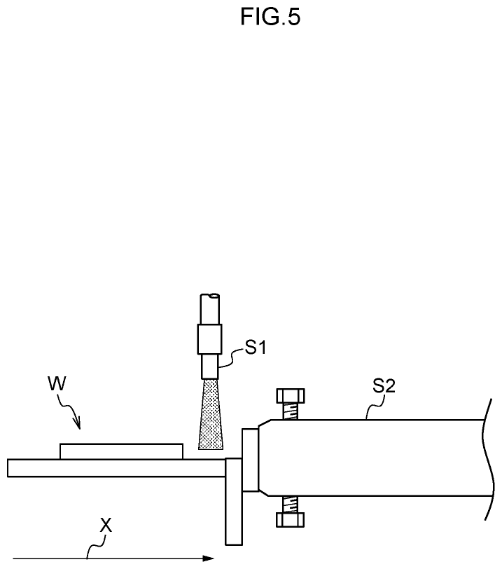

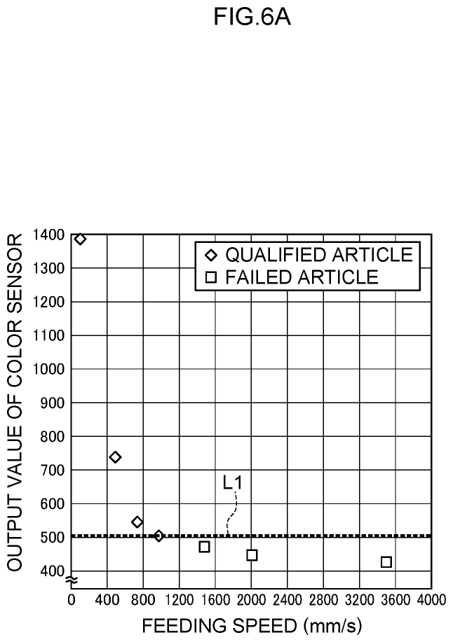

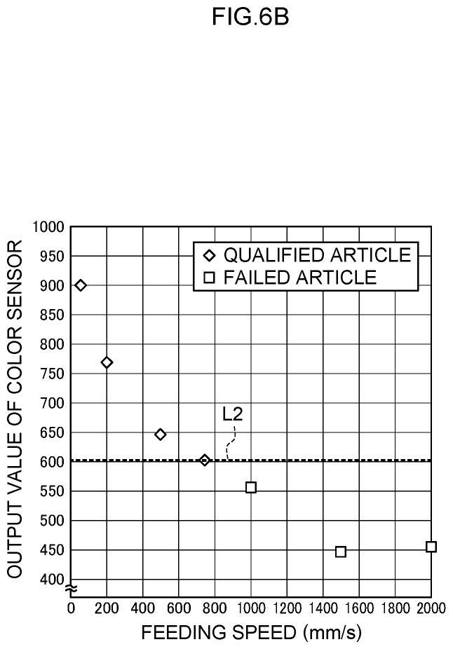

Test examples relating to judgment on qualification/failure are described next with reference to FIG. 5, FIG. 6A and FIG. 6B. A state in which an inspection target has been surface treated by shot blasting in the stage before evaluation is shown in a schematic side view in FIG. 5. Graphs of the test results are shown in FIG. 6A and FIG. 6B.

First, the test conditions are summarized. The target before the surface treatment of the inspection target is a black material (a material having an oxide film on the surface thereof) of SS400 (a rolled steel material for general structures), and is a test piece that is a square with each side being 50 mm, and that has a thickness of 6 mm. As shown in FIG. 5, shot blasting is carried out on a target W.

The first shot blasting conditions of the test whose results are shown in FIG. 6A are that cast steel shot that is spherical and has a particle diameter of 0.8 mm is used as the blasted material, and the air pressure at the time of the shot blasting is 0.1 MPa, and moreover, at the time of the shot blasting treatment, the target is moved at the feeding speeds shown by the test results in FIG. 6A. The second shot blasting conditions of the test whose results are shown in FIG. 6B are that cast steel grit having an acute angular shape and a particle diameter of 0.7 mm is used as the blasted material, and the air pressure at the time of shot blasting is 0.08 MPa, and moreover, at the time of the shot blasting treatment, the target is moved at the feeding speeds shown by the test results in FIG. 6B.

To describe this further by using FIG. 5, the target W is moved in the arrow X direction by a moving device S2 in a state in which an air nozzle S1 for shot blasting, which blasts the blasted material, is fixed. Further, the blasting density is varied by varying the feeding speed of the target W.

Further, in the evaluation of the removal of rust after the shot blasting, qualification/failure judgment is carried out by an expert, and the results of the qualification/failure judgment (i.e., the results of qualification, failing) are as shown in FIG. 6A and FIG. 6B. On the other hand, the measurement mode at the time of measuring by using the color sensor is a mode that emphasizes contrast (the contrast mode).

In FIG. 6A and FIG. 6B, the output values of the color sensor are set on the vertical axis, and the feeding speeds are set on the horizontal axis. As shown in FIG. 6A and FIG. 6B, it can be understood that, by drawing lines (dotted lines) L1, L2 that pass-through the lowest values of the output values of the qualified articles, all of the failed articles exist in the ranges beneath these lines L1, L2. From this, it can be understood that, if the lowest value of the output values of the qualified articles is made to be the qualification reference value, the qualification/failure can be determined well. Further, from FIG. 6A and FIG. 6B, it can be understood that, when the design specifications for the shot blasting treatment (broadly speaking, a surface treatment) differ, the qualification reference value also changes.

As described above, in accordance with the present embodiment, the judgment on qualification/failure can be carried out without making the color sensor 32 (the color measurement section in FIG. 1) contact the inspection target. Therefore, the processing time can be kept short, and application to a high-speed production line is possible. Note that high-speed production lines are provided on the manufacturing floors of, for example, the automotive industry, the shipbuilding industry, the steel industry, and the like.

Further, in the present embodiment, objective qualification/failure judgment on the surface state is possible, and moreover, the present embodiment can also be applied to narrow portions and parts that have complicated shapes such as connecting rods of engine parts.

### Second Embodiment

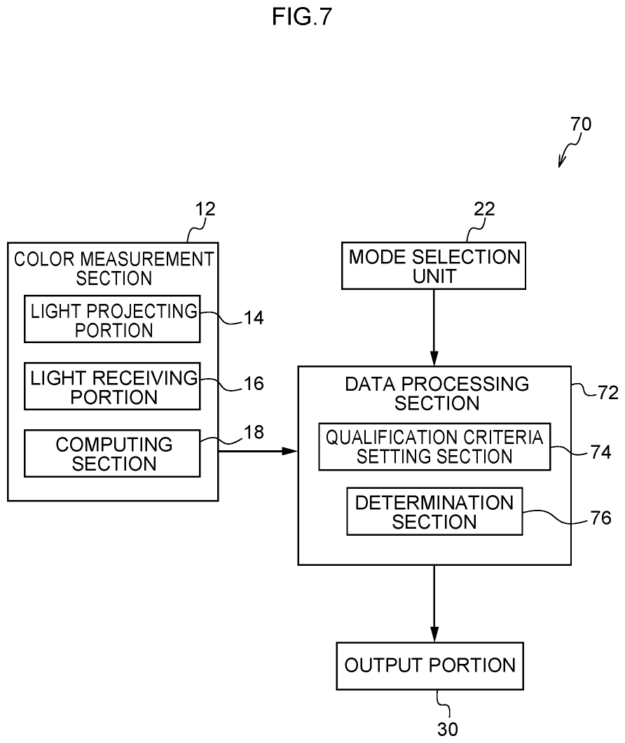

A method of evaluating a surface state of an inspection target, an evaluation device, a method of controlling an evaluation device, and a control program of an evaluation device relating to a second embodiment of the present disclosure are described next by using FIG. 7 through FIG. 9. The present embodiment is substantially similar to the first embodiment, other than the points that are described hereinafter. Accordingly, structural portions that are substantially similar to those of the first embodiment are denoted by the same reference numerals, and description thereof is omitted.

The schematic structure of an evaluation device 70 relating to the present embodiment is shown in a block drawing in FIG. 7. As shown in FIG. 7, a functional section that corresponds to the information input portion 20 (see FIG. 1) of the first embodiment does not exist at the evaluation device 70, and a data processing section 72 is provided instead of the data processing section 24.

The evaluation device 70 of the present embodiment evaluates a surface state of a product of specific design specifications as the inspection target. As an example, the evaluation device 70 is provided as auxiliary equipment of a shot blasting device that is exclusively used for a specific product. Note that, because the mode selection unit 22 is substantially similar to the mode selection unit 22 of the first embodiment, the same reference numeral is given thereto. However, among the first mode and the second mode that can be selected at the mode selection unit 22, the first mode is selected in a case in which, in operation, the surface state of a qualified article of the specific design specifications is to be measured in the present embodiment.

The data processing section 72 has a qualification reference setting section 74 and a determination section 76. The qualification reference setting section 74 is a functional section that sets a qualification reference value based on an output value output from the color measurement section 12 in the state in which the first mode is selected. Further, the determination section 76 is a functional section that compares the output value, which is output from the color measurement section 12 in the state in which the second mode is selected, with the qualification reference value, and determines the qualification/failure.

In a case in which there is a single data of the output value output from the color measurement section 12 in the first mode, the qualification reference setting section 74 sets the output value as the qualification reference value. Further, in a case in which there are plural data of the output value output from the color measurement section 12 in the first mode, the qualification reference setting section 74 sets the lowest value of these output values as the qualification reference value.

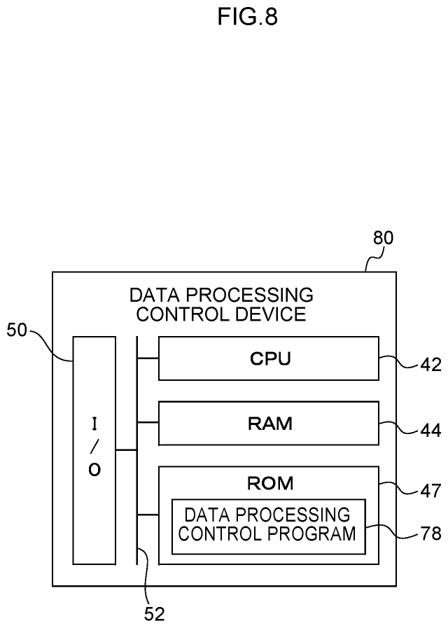

The data processing section 72 carries out data processing control for qualification/failure judgment by a data processing control device 80 that serves as a computer and is shown in FIG. 8. The schematic structure of the data processing control device 80 is shown in a block drawing in FIG. 8.

As shown in FIG. 8, the data processing control device 80 has, instead of the ROM 46 (see FIG. 2) of the first embodiment, a ROM 47 in which a data processing control program 78 (an example of the control program of an evaluation device relating to the nineteenth aspect of the present disclosure) is stored. Note that, in the same way as the ROM 46 (see FIG. 2) of the first embodiment, the ROM 47 is a non-volatile storage. The CPU 42, the RAM 44, the input/output interface portion (I/O) 50 and the bus 52 that are the other structural portions of the data processing control device 80 are similar to those of the first embodiment. The data processing control device 80 functions as the data processing section 72 (see FIG. 7) of the present embodiment due to the data processing control program 78 being read-out from the ROM 47 and being expanded in the RAM 44, and the data processing control program 78 that is expanded in the RAM 44 being executed by the CPU 42.

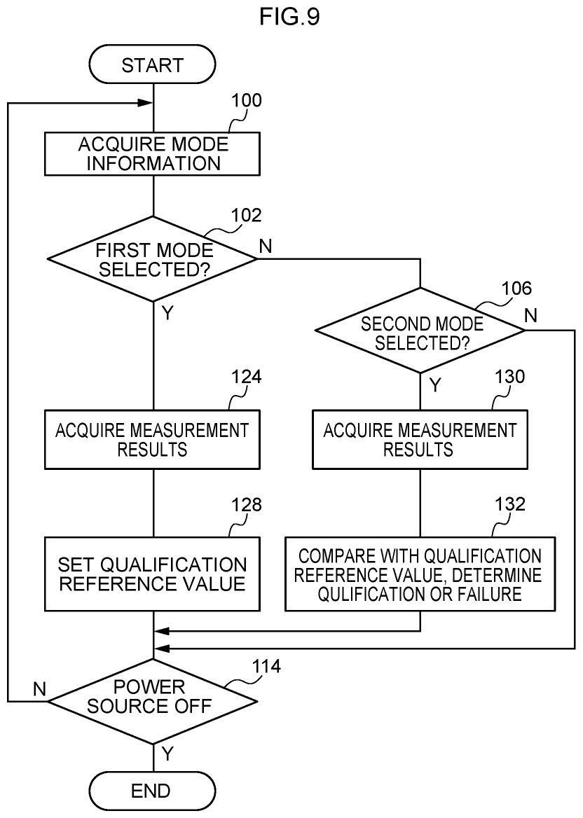

Next, an example of the flow of control processing, which is executed at the data processing section 72 (the data processing control device 80 (see FIG. 8)) at the evaluation device 70 is described as the operation of the present embodiment and with reference to the flowchart shown in FIG. 9.

As shown in FIG. 9, in the control processing of the present embodiment, instead of steps 104, 108 (see FIG. 4) of the control processing of the first embodiment, steps 124, 128 are set, and, instead of steps 110, 112 (see FIG. 4) of the control processing of the first embodiment, steps 130, 132 are set. Hereinafter, the portions that differ from the control processing of the first embodiment are described.

In step 124 that the routine moves on to in a case in which step 102 is affirmative, or in other words, in a case in which the first mode is selected, the data processing section 72 acquires the output value that is the results of measurement from the color measurement section 12. In step 128 after step 124, the data processing section 72 sets the qualification reference value based on the output value t output from the color measurement section 12 in the first mode. The routine moves on to step 114 after step 128.

Further, in step 130 that the routine moves on to in a case in which step 106 is affirmative, or in other words, in a case in which the second mode is selected, the data processing section 72 acquires the results of measurement by the color measurement section 12, i.e., the output value from the color measurement section 12. In step 132 after step 130, the data processing section 72 compares the output value, which is output from the color measurement section 12 in the state in which the second mode is selected, with the qualification reference value, and determines the qualification/failure. The routine moves on to step 114 after step 132.

In accordance with the structure of the above-described present embodiment as well, because the judgment on qualification/failure can be carried out without contacting the inspection target, application to a high-speed production line is possible.

### Third Embodiment

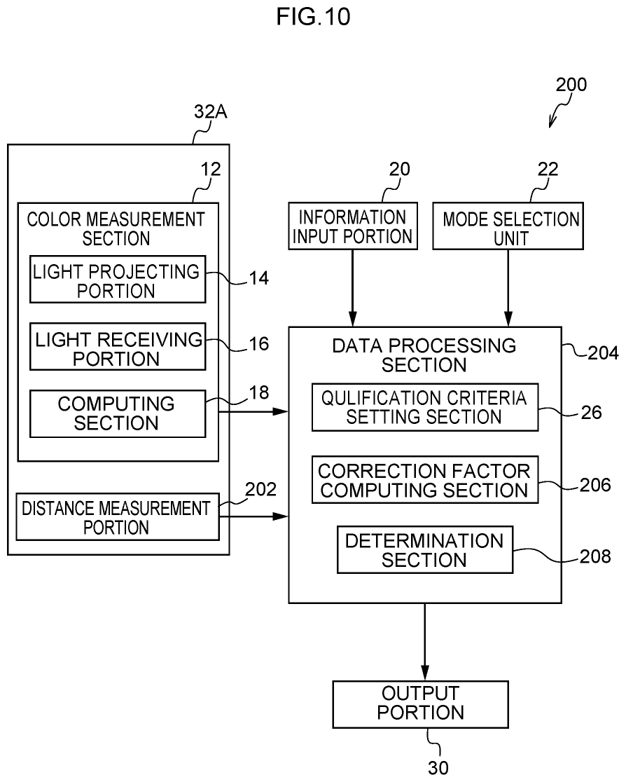

A method of evaluating a surface state of an inspection target, an evaluation device, a method of controlling an evaluation device, and a control program of an evaluation device relating to a third embodiment of the present disclosure are described next by using FIG. 10 through FIG. 13. The present embodiment is substantially similar to the first embodiment, other than the points that are described hereinafter. Accordingly, structural portions that are substantially similar to those of the first embodiment are denoted by the same reference numerals, and description thereof is omitted.

The schematic structure of an evaluation device 200 relating to the present embodiment is shown in a block drawing in FIG. 10. As shown in FIG. 10, at the evaluation device 200, a distance measurement portion 202 is provided, and, instead of the data processing section 24 (see FIG. 1) of the first embodiment, a data processing section 204 is provided.

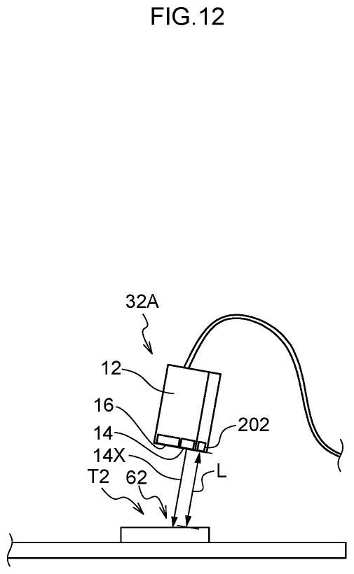

The distance measurement portion 202 is integrated with the color measurement section 12, and structures a color sensor 32A that serves as the measuring equipment shown in FIG. 12. The distance measurement portion 202 measures, without contact and with respect to the measurement target T2, clearance L, which runs along a direction 14X of light illumination central axis of the light projecting portion 14, between the measurement target T2 and a predetermined region, which faces a measurement target side, at the color sensor 32A. The distance measurement portion 202 is structured by a distance measurement meter, and a laser distance meter, an eddy current distance meter, or the like can be used for the distance measurement meter. In the present embodiment, the distance measurement portion 202 is disposed at a side of the light projecting portion 14. Note that, the color measurement section 12 and the distance measurement portion 202 respectively measure and output values in a state in which the position of the color sensor 32A with respect to the measurement target T2 does not change. The output values are stored in association with one another by the data processing section 204 (see FIG. 10) automatically or based on input information from the user.

As shown in FIG. 10, the data processing section 204 has the qualification reference setting section 26, a correction factor computing section 206, and a determination section 208. The correction factor computing section 206 is a functional section that computes a correction factor that corresponds to a clearance L along the direction 14X of the light illumination central axis of the light projecting portion 14 between the measurement target T2 and a predetermined region, which faces a measurement target side, at the color sensor 32A shown in FIG. 12, for each design specification of the measurement target. The correction factor is computed based on information from the information input portion 20 and the relationship between the output values, which are output from the color measurement section 12 in the state in which the first mode is selected, and the output values, which are output from the distance measurement portion 202 in the state in which the first mode is selected, The output values output from the color measurement section 12 and the output values output from the distance measurement portion 202 are stored in association with one another. Note that the correction factor is computed accurately by accurately grasping the dependence on distance of the color measurement section 12 shown in FIG. 10.

The determination section 208 is a functional section that corrects an output value, which is output from the color measurement section 12 in the state in which the second mode is selected, by the correction factor that corresponds to an output value, which is output from the distance measurement portion 202 in the state in which the second mode is selected, and to information of the design specifications of the measurement target. The determination section 208 compares the corrected value (in other words, the corrected value obtained by correcting the output value output from the color measurement section 12, in accordance with the measurement conditions at the time of measurement thereof and based on a predetermined criterion) with the qualification reference value for a product of the same design specifications as the measurement target, and determines the qualification/failure.

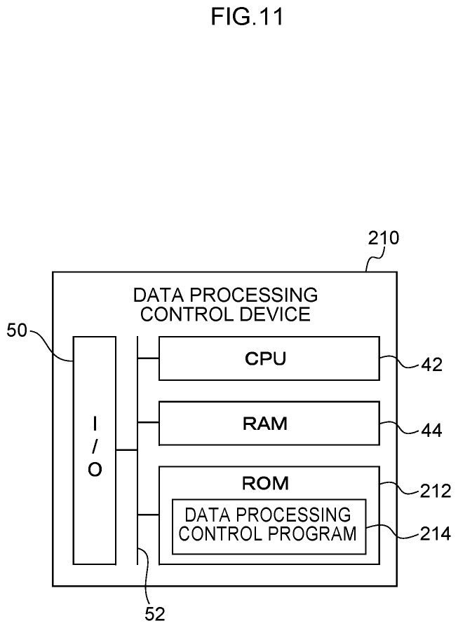

The data processing section 204 carries out data processing control for qualification/failure judgment by a data processing control device 210 that serves as a computer and is shown in FIG. 11. The schematic structure of the data processing control device 210 is shown in a block drawing in FIG. 11.

As shown in FIG. 11, the data processing control device 210 has, instead of the ROM 46 (see FIG. 2) of the first embodiment, a ROM 212 in which is stored a data processing control program 214 (an example of the control program of an evaluation device relating to the twentieth aspect of the present disclosure). Note that, in the same way as the ROM 46 (see FIG. 2) of the first embodiment, the ROM 212 is a non-volatile storage. The CPU 42, the RAM 44, the input/output interface portion (I/O) 50 and the bus 52 that are the other structural portions of the data processing control device 210 are similar to those of the first embodiment. Note that the distance measurement portion 202 (see FIG. 12) also is connected to the I/O 50 of the present embodiment. The data processing control device 210 functions as the data processing section 204 (see FIG. 10) due to the data processing control program 214 being read-out from the ROM 212 and being expanded in the RAM 44, and the data processing control program 214 that is expanded in the RAM 44 being executed by the CPU 42.

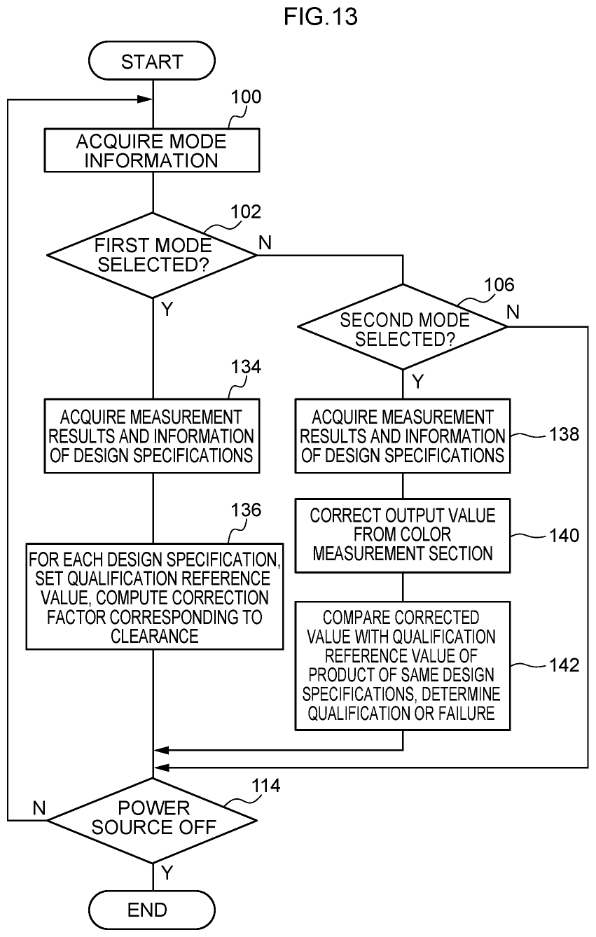

Next, an example of the flow of control processing, which is executed at the data processing section 204 (the data processing control device 210 (see FIG. 11)) at the evaluation device 200 is described as the operation of the present embodiment and with reference to the flowchart shown in FIG. 13.

As shown in FIG. 13, in the control processing of the present embodiment, instead of steps 104, 108 (see FIG. 4) of the control processing of the first embodiment, steps 134, 136 are set, and, instead of steps 110, 112 (see FIG. 4) of the control processing of the first embodiment, steps 138, 140, 142 are set. Hereinafter, the portions that differ from the control processing of the first embodiment are described.

In step 134 that the routine moves on to in a case in which step 102 is affirmative, or in other words, in a case in which the first mode is selected, the data processing section 204 acquires output values that are the results of measurement respectively output from the color measurement section 12 and the distance measurement portion 202 in the state in which the first mode is selected, and acquires information of the design specifications of the measurement target that was inputted at the information input portion 20. In step 136 after step 134, at the data processing section 204, the qualification reference setting section 26 sets a qualification reference value for each design specification of the measurement target, and the correction factor computing section 206 computes, for each design specification of the measurement target, a correction factor that corresponds to the clearance L between the measurement target T2 and a predetermined region, which faces the measurement target side, at the color sensor 32A. At this time, the correction factor computing section 206 computes the correction factor that corresponds to the clearance L, based on the information from the information input portion 20 and the relationship between the output value, which is output from the color measurement section 12, and the output value, which is output from the distance measurement portion 202, in the state in which the first mode is selected. The output value of the color measurement section 12 and the output value of the distance measurement portion 202 are stored in association with one another. The routine moves on to step 114 after step 136.

Further, in step 138 that the routine moves on to in a case in which step 106 is affirmative, or in other words, in a case in which the second mode is selected, the data processing section 204 acquires output values that are the results of measurement respectively output from the color measurement section 12 and the distance measurement portion 202 in the state in which the second mode is selected, and acquires information of the design specifications of the measurement target that was inputted at the information input portion 20. In step 140 after step 138, the determination section 208 of the data processing section 204 corrects the output value output from the color measurement section 12, by the correction factor that corresponds to the output value output from the distance measurement portion 202 and to the information of the design specifications of the measurement target. In step 142 after step 140, the determination section 208 compares the corrected value that is determined in step 140 (in other words, the corrected value obtained by correcting the output value, which is output from the color measurement section 12, in accordance with the measurement conditions at the time of measurement thereof and based on a predetermined criterion) with the qualification reference value for the product of the same design specifications as the measurement target, and determines the qualification/failure. The routine moves on to step 114 after step 142.

The method of evaluating a surface state of an inspection target by using the color sensor 32A and the distance measurement portion 202 shown in FIG. 12 and the data processing control device 210 shown in FIG. 11 is described next.

In the method of evaluating a surface state of an inspection target, before one point on the surface of the inspection target is measured by the color sensor 32A, one point on the surface of a qualified article is measured by the color measurement section 12 in plural patterns that vary the clearance L between the surface of the qualified article and a predetermined region, which faces the measurement target side at the color sensor 32A. The clearance L is measured by the distance measurement portion 202 at the color sensor 32A. The data processing control device 210 (more specifically, the correction factor computing section 206 shown in FIG. 10) computes a correction factor that corresponds to respective clearance L, from the relationship between the output values of the distance measurement portion 202 and the output values relating to color of the color sensor 32A, in the plural patterns. Further, the data processing control device 210 (more specifically, the qualification reference setting section 26 of FIG. 10) sets the qualification reference values based on the output values relating to color of the color sensor 32A.

Thereafter, one point on the surface of the inspection target, which has the same design specifications as the qualified article, is measured without contact by the color measurement section 12 of the color sensor 32A. Further, the clearance L between the surface of the inspection target and a predetermined region, which faces the measurement target side, at the color sensor 32A is measured, without contacting the inspection target, by the distance measurement portion 202. Further, the data processing control device 210 (refer to FIG. 11, and, more specifically, the determination section 208 of FIG. 10) corrects the output value, which relates to color at the time of measuring the one point on the surface of the inspection target by the color measurement section 12 without contact, by the correction factor that corresponds to the value measured by the distance measurement portion 202, and compares the corrected value (in other words, the corrected value obtained by correcting the output value, which relates to color and is output from the color measurement section 12, in accordance with the measurement conditions at the time of measurement thereof and based on a predetermined criterion) with the qualification reference value, and determines the qualification/failure.

In accordance with the structure of the above-described present embodiment as well, because the determination on qualification or failure can be carried out without contacting the inspection target, application to a high-speed production line is possible. Further, in the present embodiment, qualification or failure can be determined accurately even if there is dispersion in the clearance between the light projecting portion 14 of the color sensor 32A and the measurement point on the surface of the inspection target.

### Fourth Embodiment

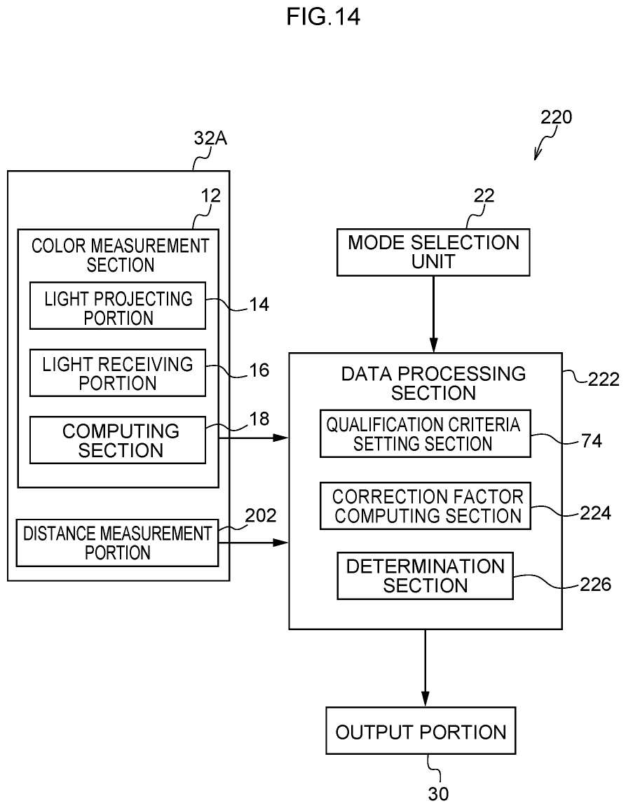

A method of evaluating a surface state of an inspection target, an evaluation device, a method of controlling an evaluation device, and a control program of an evaluation device relating to a fourth embodiment of the present disclosure are described next by using FIG. 14 through FIG. 16. The present embodiment is substantially similar to the third embodiment, other than the points that are described hereinafter. Accordingly, structural portions that are substantially similar to those of the third embodiment are denoted by the same reference numerals, and description thereof is omitted.

The schematic structure of an evaluation device 220 relating to the present embodiment is shown in a block drawing in FIG. 14. As shown in FIG. 14, at the evaluation device 220, a functional portion corresponding to the information input portion 20 (see FIG. 10) of the third embodiment does not exist, and a data processing section 222 is provided instead of the data processing section 204. Note that, in the same way as the data processing section 204 of the third embodiment, the data processing section 222 stores the output values, which are respectively measured by and output from the color measurement section 12 and the distance measurement portion 202 in a state in which the position of the color sensor 32A with respect to the measurement target T2 (see FIG. 12) is not changed, in association with one another and automatically or based on input information from the user.

In the same way as in the second embodiment, the evaluation device 220 of the present embodiment evaluates a surface state of a product of specific design specifications as the inspection target. Note that, because the mode selection unit 22 is substantially similar to the mode selection unit 22 of the third embodiment, the same reference numeral is given thereto. However, among the first mode and the second mode that can be selected at the mode selection unit 22, the first mode in the present embodiment is selected in a case in which, in operation, the surface state of a qualified article of specific design specifications is to be measured.

The data processing section 222 has the qualification reference setting section 74, a correction factor computing section 224, and a determination section 226. Because the qualification reference setting section 74 is a functional section that is similar to the qualification reference setting section 74 of the second embodiment, detailed description thereof is omitted.

The correction factor computing section 224 is a functional section that computes a correction factor, which corresponds to a clearance L (see FIG. 12), which runs along a direction 14X of the light illumination central axis (see FIG. 12) of the light projecting portion 14, between the measurement target T2 (see FIG. 12) and a predetermined region, which faces the measurement target side, at the color measurement section 12. The correction factor is computed based on the relationship between an output value, which is output from the color measurement section 12 in the state in which the first mode is selected, and an output value, which is output from the distance measurement portion 202 in the state in which the first mode is selected. The output values are stored in association with one another. Further, the determination section 226 is a functional section that corrects an output value, which is output from the color measurement section 12 in the state in which the second mode is selected, by the correction factor that corresponds to an output value, which is output from the distance measurement portion 202 in the state in which the second mode is selected, and compares the corrected value (in other words, the corrected value obtained by correcting the output value, which is output from the color measurement section 12, in accordance with the measurement conditions at the time of measurement thereof and based on a predetermined criterion) with the qualification reference value, and determines the qualification/failure.

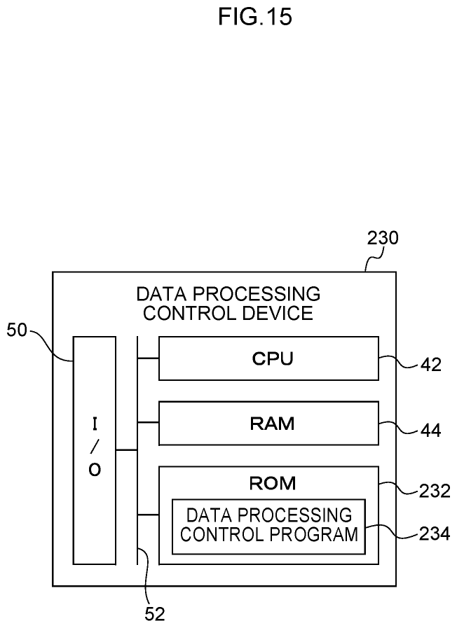

The data processing section 222 carries out data processing control for qualification/failure judgment by a data processing control device 230 that serves as a computer and is shown in FIG. 15. The schematic structure of the data processing control device 230 is shown in a block drawing in FIG. 15.

As shown in FIG. 15, the data processing control device 230 has, instead of the ROM 212 (see FIG. 11) of the third embodiment, a ROM 232 in which a data processing control program 234 (an example of the control program of an evaluation device relating to the nineteenth aspect of the present disclosure) is stored. Note that, in the same way as the ROM 212 (see FIG. 11) of the third embodiment, the ROM 232 is a non-volatile storage. The CPU 42, the RAM 44, the input/output interface portion (I/O) 50 and the bus 52 that are the other structural portions of the data processing control device 230 are similar to those of the third embodiment. The data processing control device 230 functions as the data processing section 222 (see FIG. 14) due to the data processing control program 234 being read-out from the ROM 232 and being expanded in the RAM 44, and the data processing control program 234 that is expanded in the RAM 44 being executed by the CPU 42.

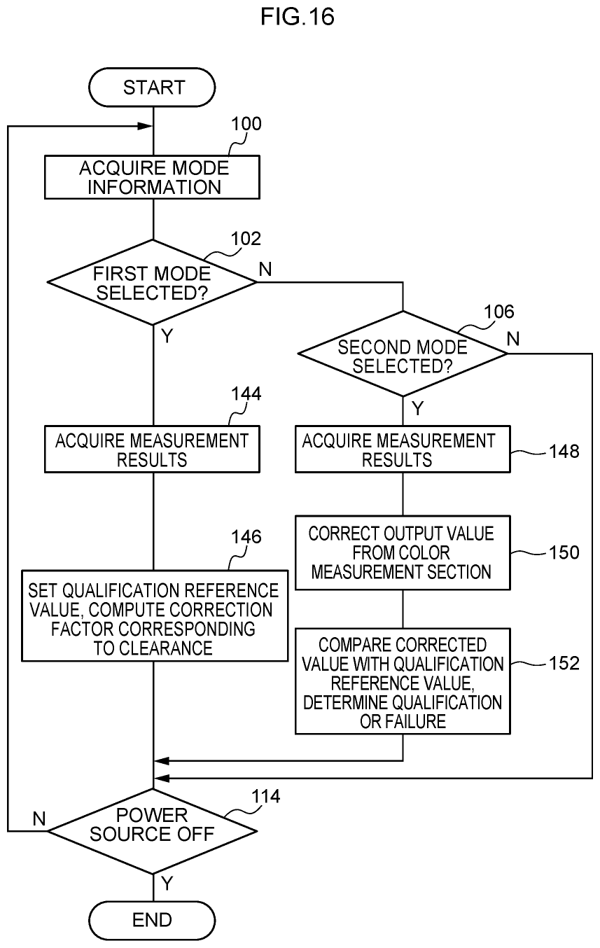

Next, an example of the flow of control processing, which is executed at the data processing section 222 (the data processing control device 230 (see FIG. 15)) at the evaluation device 220 shown in FIG. 14, is described as the operation of the present embodiment and with reference to the flowchart shown in FIG. 16.

As shown in FIG. 16, in the control processing of the present embodiment, instead of steps 134, 136 (see FIG. 13) of the control processing of the third embodiment, steps 144, 146 are set, and, instead of steps 138, 140, 142 (see FIG. 13) of the control processing of the third embodiment, steps 148, 150, 152 are set. Hereinafter, the portions that differ from the control processing of the third embodiment are described.

In step 144 that the routine moves on to in a case in which step 102 is affirmative, or in other words, in a case in which the first mode is selected, the data processing section 222 acquires output values that are the results of measurement respectively output from the color measurement section 12 and the distance measurement portion 202 in the state in which the first mode is selected. In step 146 after step 144, at the data processing section 222, the qualification reference setting section 74 sets qualification reference values, and the correction factor computing section 224 computes correction factors that correspond to the respective clearance L between a measurement target T2 and the predetermined region, which faces the measurement target side, at the color measurement section 12. At this time, the correction factor computing section 224 computes the correction factors that correspond to the respective clearance L, based on the relationship between the output values, which are output from the color measurement section 12 in the state in which the first mode is selected, and the output values, which are output from the distance measurement portion 202 in the state in which the first mode is selected. The output values output from the color measurement section 12 and the output values output from the distance measurement portion 202 are stored in association with one another. The routine moves on to step 114 after step 146.

Further, in step 148 that the routine moves on to in a case in which step 106 is affirmative, or in other words, in a case in which the second mode is selected, the data processing section 222 acquires the output values that are the results of measurement respectively output from the color measurement section 12 and the distance measurement portion 202 in the state in which the second mode is selected. In step 150 after step 148, the determination section 226 of the data processing section 222 corrects the output value, which is output from the color measurement section 12 in the second mode, by the correction factor that corresponds to an output value output from the distance measurement portion 202 in the state in which the second mode is selected. In step 152 after step 150, the determination section 226 compares the corrected value determined in step 150 (in other words, the corrected value obtained by correcting the output value, which is output from the color measurement section 12, in accordance with the measurement conditions at the time of measurement thereof and based on a predetermined criterion) with the qualification reference value, and determines the qualification/failure. The routine moves on to step 114 after step 152.

Note that, if the evaluation device 220 that is shown in FIG. 14 is used, a method of evaluating a surface state of an inspection target can be implemented in the same way as in the third embodiment.

In accordance with the structure of the above-described present embodiment as well, because a determination on qualification or failure can be carried out without contacting the inspection target, application to a high-speed production line is possible. Further, in the present embodiment, in the same way as in the third embodiment, qualification/failure can be determined accurately even if there is dispersion in the clearance between the light projecting portion 14 and the measurement point on the surface of the inspection target.

### Fifth Embodiment

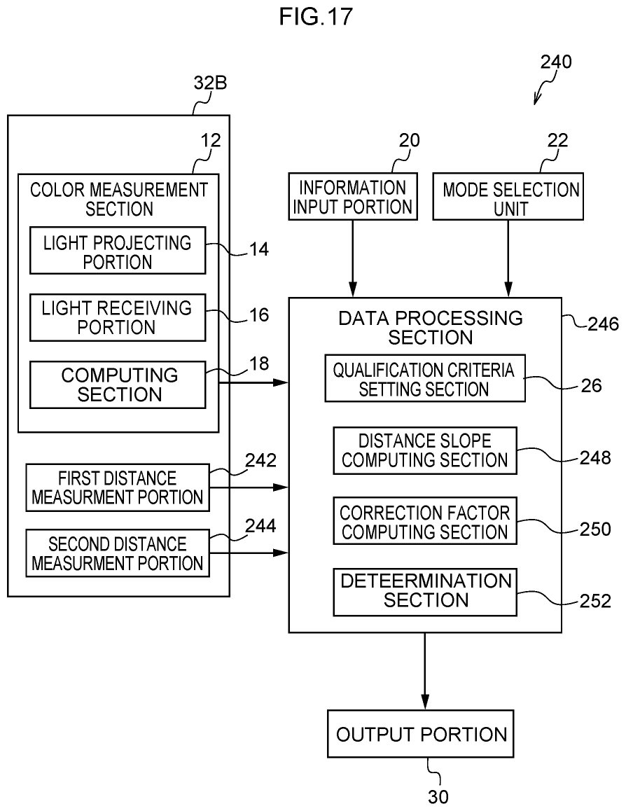

A method of evaluating a surface state of an inspection target, an evaluation device, a method of controlling an evaluation device, and a control program of an evaluation device relating to a fifth embodiment of the present disclosure are described next by using FIG. 17 through FIG. 20. The present embodiment is substantially similar to the first embodiment, other than the points that are described hereinafter. Accordingly, structural portions that are substantially similar to those of the first embodiment are denoted by the same reference numerals, and description thereof is omitted.

The schematic structure of an evaluation device 240 relating to the present embodiment is shown in a block drawing in FIG. 17. As shown in FIG. 17, at the evaluation device 240, a first distance measurement portion 242 and a second distance measurement portion 244 that serve as two distance measurement portions are provided, and, instead of the data processing section 24 (see FIG. 1) of the first embodiment, a data processing section 246 is provided.

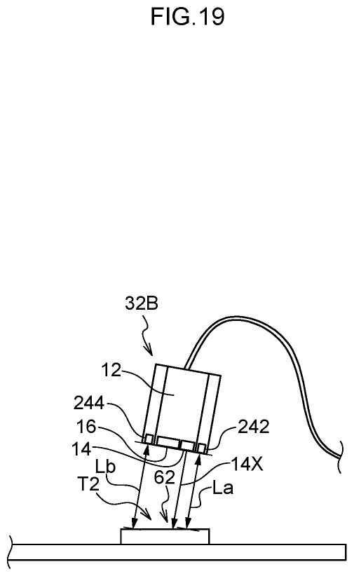

The first distance measurement portion 242 and the second distance measurement portion 244 are disposed at both sides of the color measurement section 12 in a direction in which the light projecting portion 14 and the light receiving portion 16 that are shown in FIG. 19 are lined-up. The first distance measurement portion 242 and the second distance measurement portion 244 are integrated with the color measurement section 12, and structure a color sensor 32B that serves as the measuring equipment. The first distance measurement portion 242 and the second distance measurement portion 244 respectively measure, without contact and with respect to a measurement target T2, clearances La, Lb, which run along a direction 14X of the light illumination central axis of the light projecting portion 14, between the measurement target T2 and a predetermined region, which faces the measurement target side, at the color sensor 32B. In the same way as the distance measurement portion 202 of the third embodiment, the first distance measurement portion 242 and the second distance measurement portion 244 are structured by distance measurement meters, and laser distance meters, eddy current distance meters, or the like can be used for the distance measurement meters. Note that the output values, which the color measurement section 12, the first distance measurement portion 242, and the second distance measurement portion 244 respectively measure and output in a state in which the position of the color sensor 32B with respect to the measurement target T2 is not changed, are stored in association with one another by the data processing section 246 (see FIG. 17) automatically or based on input information from the user.

As shown in FIG. 17, the data processing section 246 has the qualification reference setting section 26, a distance inclination computing section 248, a correction factor computing section 250, and a determination section 252. The distance inclination computing section 248 is a functional section that, from the output values that are respectively output from the first distance measurement portion 242 and the second distance measurement portion 244, computes an average value of the clearances La, Lb along the direction 14X of the light illumination central axis of the light projecting portion 14 between the measurement target T2 and a predetermined region, which faces the measurement target side, at the color sensor 32B shown in FIG. 19. The distance inclination computing section 248 computes an inclination of the direction 14X of the light illumination central axis of the light projecting portion 14 with respect to a direction orthogonal to the measurement target surface 62.

The correction factor computing section 250 shown in FIG. 17 is a functional section that computes a correction factor that corresponds to an average clearance, which is the average value of the clearances La, Lb between the measurement target T2 and a predetermined region, which faces the measurement target side, at the color sensor 32B shown in FIG. 19 and to the inclination of the direction 14X of the light illumination central axis of the light projecting portion 14 with respect to the direction orthogonal to the measurement target surface 62, for each design specification of the measurement target. The correction factor is computed based on information from the information input portion 20 and the relationship between the output value, which is output from the color measurement section 12 in the state in which the first mode is selected, and a computed value, which is computed by the distance inclination computing section 248 based on the output values that are respectively output from the first distance measurement portion 242 and the second distance measurement portion 244 in the state in which the first mode is selected. The output value output from the color measurement section 12 and the computed value computed by the distance inclination computing section 248 are stored in association with one another.

Further, the determination section 252 that is shown in FIG. 17 is a functional section that corrects the output value, which is output from the color measurement section 12 in the state in which the second mode is selected, by a correction factor that corresponds to the information of the design specifications of the measurement target and a computed value that is computed by the distance inclination computing section 248 based on the output values respectively output from the first distance measurement portion 242 and the second distance measurement portion 244 in the state in which the second mode is selected. The determination section 252 compares the corrected value (in other words, the corrected value obtained by correcting the output value, which is output from the color measurement section 12, in accordance with the measurement conditions at the time of measurement thereof and based on a predetermined criterion) with the qualification reference value for a product of the same design specifications as the measurement target, and determines the qualification/failure.

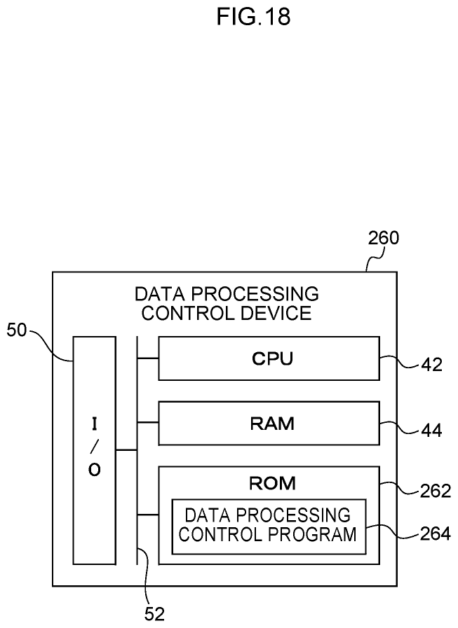

The data processing section 246 carries out data processing control for qualification/failure judgment by a data processing control device 260 that serves as a computer and is shown in FIG. 18. The schematic structure of the data processing control device 260 is shown in a block drawing in FIG. 18.

As shown in FIG. 18, the data processing control device 260 has, instead of the ROM 46 (see FIG. 2) of the first embodiment, a ROM 262 in which a data processing control program 264 (an example of the control program of an evaluation device relating to the twentieth aspect of the present disclosure) is stored. Note that, in the same way as the ROM 46 (see FIG. 2) of the first embodiment, the ROM 262 is a non-volatile storage. The CPU 42, the RAM 44, the input/output interface portion (I/O) 50 and the bus 52 that are the other structural portions of the data processing control device 260 are similar to those of the first embodiment. Note that the first distance measurement portion 242 and the second distance measurement portion 244 (see FIG. 19 for both) also are connected to the I/O 50 of the present embodiment. The data processing control device 260 functions as the data processing section 246 (see FIG. 17) of the present embodiment due to the data processing control program 264 being read-out from the ROM 262 and being expanded in the RAM 44, and the data processing control program 264 that is expanded in the RAM 44 being executed by the CPU 42.

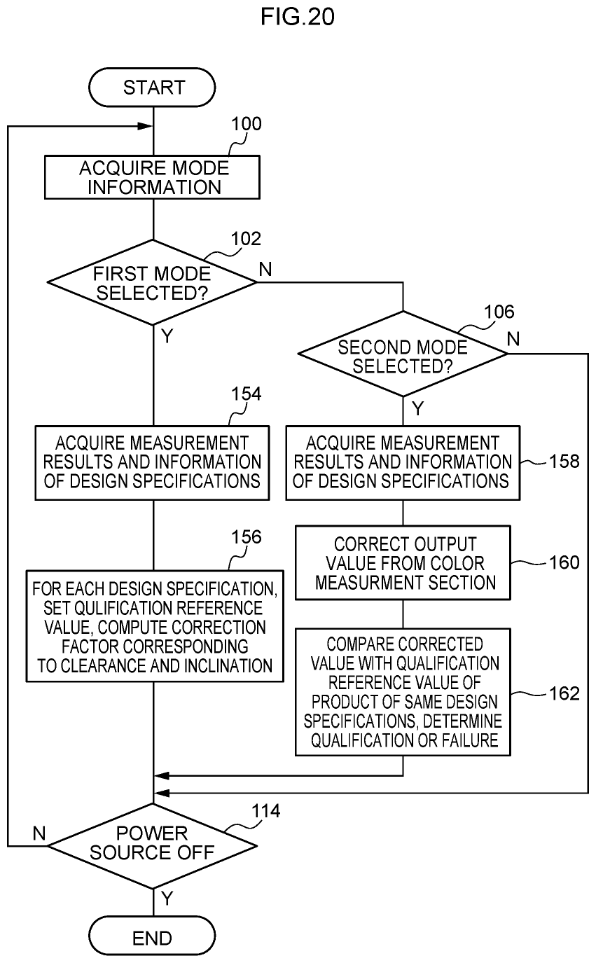

Next, an example of the flow of control processing, which is executed at the data processing section 246 (the data processing control device 260 (see FIG. 18)) at the evaluation device 240 shown in FIG. 17, is described as the operation of the present embodiment and with reference to the flowchart shown in FIG. 20.

As shown in FIG. 20, in the control processing of the present embodiment, instead of steps 104, 108 (see FIG. 4) of the control processing of the first embodiment, steps 154, 156 are set, and, instead of steps 110, 112 (see FIG. 4) of the control processing of the first embodiment, steps 158, 160, 162 are set. Hereinafter, the portions that differ from the control processing of the first embodiment are described.

In step 154 that the routine moves on to in a case in which step 102 is affirmative, or in other words, in a case in which the first mode is selected, the data processing section 246 acquires the output values that are the results of measurement that are respectively output from the color measurement section 12, the first distance measurement portion 242 and the second distance measurement portion 244 in the state in which the first mode is selected, and acquires information of the design specifications of the measurement target that was inputted at the information input portion 20.

In step 156 after step 154, at the data processing section 246, the qualification reference setting section 26 sets a qualification reference value for each of the design specifications of the measurement targets. Further, in step 156, at the data processing section 246, after the distance inclination computing section 248 carries out the above-described predetermined computation, the correction factor computing section 250 computes, for each of the design specifications of the measurement targets, a correction factor that corresponds to an average clearance that is the average value of the clearances La, Lb between the measurement target T2 and a predetermined region, which faces the measurement target side, at the color sensor 32B, and to the inclination of the light illumination central axis direction 14X of the light projecting portion 14 with respect to the direction orthogonal to the measurement target surface 62. To describe this further, before the correction factor computing section 250 computes the correction factor, the distance inclination computing section 248, from the output values that are respectively output from the first distance measurement portion 242 and the second distance measurement portion 244 in the state in which the first mode is selected, computes the average value of the clearances La, Lb, and computes the inclination of the direction 14X of the light illumination central axis of the light projecting portion 14 with respect to the direction orthogonal to the measurement target surface 62. Then, the correction factor computing section 250 computes a correction factor that corresponds to the above-described average clearance and the above-described inclination, based on information from the information input portion 20 and the relationship between the output value, which is output from the color measurement section 12 in the state in which the first mode is selected, and a computed value, which is computed by the distance inclination computing section 248 based on the output values that are respectively output from the first distance measurement portion 242 and the second distance measurement portion 244 in the state in which the first mode is selected. The output values from the color measurement section 12 and the computed value computed by the distance inclination computing section 248 are stored in association with one another. The routine moves on to step 114 after step 156.

Further, in step 158 that the routine moves on to in a case in which step 106 is affirmative, or in other words, in a case in which the second mode is selected, the data processing section 246 acquires output values that are the results of measurement respectively output from the color measurement section 12, the first distance measurement portion 242 and the second distance measurement portion 244 in the state in which the second mode is selected, and acquires information of the design specifications of the measurement target that was inputted at the information input portion 20.

In step 160 after step 158, the data processing section 246 corrects the output value that is output from the color measurement section 12 in the state in which the second mode is selected. To describe this more concretely, first, from the output values that are respectively output from the first distance measurement portion 242 and the second distance measurement portion 244 in the second mode, the distance inclination computing section 248 computes the average value of the clearances La, Lb at the color sensor 32B, and computes the inclination of the direction 14X of the light illumination central axis of the light projecting portion 14 with respect to the direction orthogonal to the measurement target surface 62. Then, the determination section 252 of the data processing section 246 corrects the output value output from the color measurement section 12 in the second mode, by the correction factor that corresponds to the information of the design specifications of the measurement target and the computed value that is computed by the distance inclination computing section 248 based on the output values respectively output from the first distance measurement portion 242 and the second distance measurement portion 244 in the second mode.

In step 162 after step 160, the determination section 252 of the data processing section 246 compares the corrected value determined in step 160 (in other words, the corrected value obtained by correcting the output value, which is output from the color measurement section 12, in accordance with the measurement conditions at the time of measurement thereof and based on a predetermined criterion) with the qualification reference value for a product of the same design specifications as the measurement target, and determines the qualification or failure. The routine moves on to step 114 that is next after step 162.

The method of evaluating a surface state of an inspection target by using the color sensor 32B, the first distance measurement portion 242 and the second distance measurement portion 244 shown in FIG. 19, and the data processing control device 260 shown in FIG. 18 is described next.

In the method of evaluating a surface state of an inspection target, before one point on the surface of an inspection target is measured by the color sensor 32B shown in FIG. 19, one point on the surface of a qualified article is measured by the color sensor 32B in plural patterns that vary the conditions, which are the clearances La, Lb between the surface of the qualified article and a predetermined region, which faces the measurement target side, at the color sensor 32B, and the inclination of the direction 14X of the light illumination central axis of the light projecting portion 14 with respect to the direction orthogonal to the measured portion on the surface of the qualified article. The clearances La, Lb are respectively measured by the first distance measurement portion 242 and the second distance measurement portion 244. Moreover, the data processing control device 260 (more specifically, the distance computing section 248 of FIG. 17) computes the average value of the clearances La, Lb and the aforementioned inclination as first data, from the results of measurement by the first distance measurement portion 242 and the second distance measurement portion 244. Further, the data processing control device 260 (more specifically, the correction factor computing section 250 of FIG. 17) computes in advance a correction factor that corresponds to the above-described inclination and the average clearance that is the average value of the clearances La, Lb, from the relationship between the above-described first data and the output value relating to color of the color sensor 32B in the plural patterns. Further, the data processing control device 260 (more specifically, the qualification reference setting section 26 of FIG. 17) sets the qualification reference value based on the output value relating to color of the color sensor 32B.

Thereafter, one point on the surface of the inspection target, which has the same design specifications as the qualified article, is measured without contact by the color measurement section 12 of the color sensor 32B. Further, the clearances La, Lb between the surface of the inspection target and a predetermined region, which faces the measurement target side, at the color sensor 32B are respectively measured without contacting the inspection target by the first distance measurement portion 242 and the second distance measurement portion 244. Moreover, from these two results of measurement, the data processing control device 260 (more specifically, the distance inclination computing section 248 of FIG. 17) computes, as second data, the average value of the clearances La, Lb, and the inclination of the direction 14X of the light illumination central axis of the light projecting portion 14 with respect to the direction orthogonal to the measured portion of the surface of the inspection target. Then, the data processing control device 260 (more specifically, the determination section 252 of FIG. 17) corrects, by the correction factor that corresponds to the above-described second data, the output value that relates to color at the time when the one point on the surface of the inspection target is measured without contact by the color measurement section 12 of the color sensor 32B, and compares that corrected value (in other words, the corrected value obtained by correcting the output value, which relates to color and is output from the color measurement section 12 of the color sensor 32B, in accordance with the measurement conditions at the time of measurement thereof and based on a predetermined criterion) with the qualification reference value, and determines the qualification or failure.

In accordance with the structure of the above-described present embodiment as well, because the determination on qualification/failure can be carried out without contacting the inspection target, the present embodiment can be applied to a high-speed production line. Further, in the present embodiment, qualification/failure can be determined accurately even if there is dispersion in both of or one of the clearance between the light projecting portion 14 of the color sensor 32B and the measurement point on the surface of the inspection target, and the inclination of the direction 14X of the light illumination central axis of the light projecting portion 14. Therefore, in the present embodiment, the qualification/failure can be determined accurately even in a case in which the surface of the inspection target is curved or a case in which the inspection target is shaped as a cylindrical rod for example.

### Sixth Embodiment

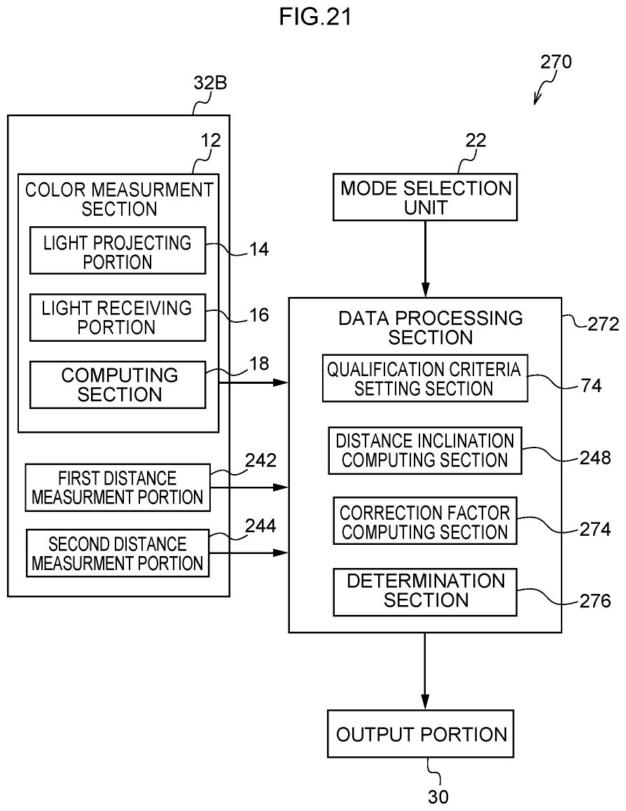

A method of evaluating a surface state of an inspection target, an evaluation device, a method of controlling an evaluation device, and a control program of an evaluation device relating to a sixth embodiment of the present disclosure are described next by using FIG. 21 through FIG. 23. The present embodiment is substantially similar to the fifth embodiment, other than the points that are described hereinafter. Accordingly, structural portions that are substantially similar to those of the fifth embodiment are denoted by the same reference numerals, and description thereof is omitted.

The schematic structure of an evaluation device 270 relating to the present embodiment is shown in a block drawing in FIG. 21. As shown in FIG. 21, at the evaluation device 270 of the present embodiment, a functional portion corresponding to the information input portion 20 (see FIG. 17) of the fifth embodiment does not exist, and a data processing section 272 is provided instead of the data processing section 246. Note that, in the same way as the data processing section 246 of the fifth embodiment, the data processing section 272 stores the output values that are respectively measured by and output from the color measurement section 12, the first distance measurement portion 242 and the second distance measurement portion 244 in a state in which the position of the color sensor 32B with respect to the measurement target T2 (see FIG. 19) is not changed, in association with one another automatically or based on input information from the user.

In the same way as in the second and fourth embodiments, the evaluation device 270 of the present embodiment evaluates a surface state of a product of specific design specifications as the inspection target. Note that, because the mode selection unit 22 is substantially similar to the mode selection unit 22 of the fifth embodiment, the same reference numeral is given thereto. However, among the first mode and the second mode that can be selected at the mode selection unit 22, the first mode in the present embodiment is selected in a case in which, in operation, a surface state of a qualified article of the specific design specifications is to be measured.

The data processing section 272 has the qualification reference setting section 74, the distance inclination computing section 248, a correction factor computing section 274, and a determination section 276. The qualification reference setting section 74 is a functional section that is similar to the qualification reference setting section 74 of the second and fourth embodiments. Further, the distance inclination computing section 248 is a functional section that is similar to the distance inclination computing section 248 of the fifth embodiment.

The correction factor computing section 274 is a functional section that computes a correction factor, which corresponds to the average clearance that is the average value of the clearances La, Lb between the measurement target T2 and a predetermined region, which faces the measurement target side, at the color sensor 32B shown in FIG. 19, and to the inclination of the direction 14X of the light illumination central axis of the light projecting portion 14 with respect to the direction orthogonal to the measurement target surface 62. The correction factor is computed based on the relationship between the output value output from the color measurement section 12 in the state in which the first mode is selected, and a computed value that is computed by the distance inclination computing section 248 based on the output values respectively output from the first distance measurement portion 242 and the second distance measurement portion 244 in the state in which the first mode is selected. The output value and the computed value in the first mode are stored in association with one another.

The determination section 276 shown in FIG. 21 is a functional section that corrects an output value, which is output from the color measurement section 12 in the state in which the second mode is selected, by a correction factor. The correction factor corresponds to a computed value computed by the distance inclination computing section 248 based on output values respectively output from the first distance measurement portion 242 and the second distance measurement portion 244 in the state in which the second mode is selected. The determination section 276 compares the corrected value (in other words, the corrected value obtained by correcting the output value, which is output from the color measurement section 12, in accordance with the measurement conditions at the time of measurement thereof and based on a predetermined criterion) with the qualification reference value, and determines the qualification/failure.

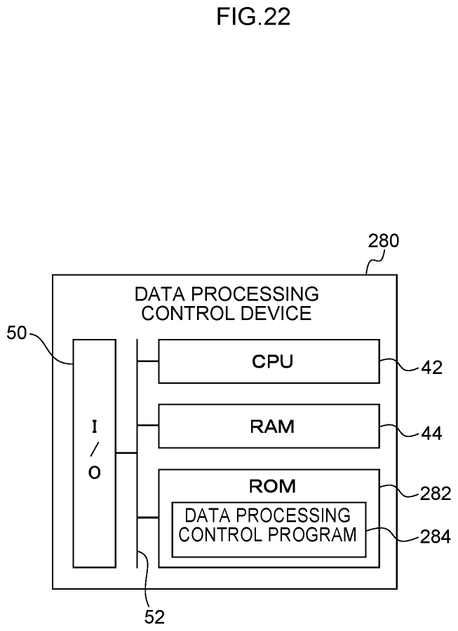

The data processing section 272 carries out data processing control for qualification/failure judgment by a data processing control device 280 that serves as a computer and is shown in FIG. 22. The schematic structure of the data processing control device 280 is shown in a block drawing in FIG. 22.

As shown in FIG. 22, the data processing control device 280 has, instead of the ROM 262 (see FIG. 18) of the fifth embodiment, a ROM 282 in which a data processing control program 284 (an example of the control program of an evaluation device relating to the nineteenth aspect of the present disclosure) is stored. Note that, in the same way as the ROM 262 (see FIG. 18) of the fifth embodiment, the ROM 282 is a non-volatile storage. The CPU 42, the RAM 44, the input/output interface portion (I/O) 50 and the bus 52 that are the other structural portions of the data processing control device 280 are similar to those of the fifth embodiment. The data processing control device 280 functions as the data processing section 272 (see FIG. 21) due to the data processing control program 284 being read-out from the ROM 282 and being expanded in the RAM 44, and the data processing control program 284 that is expanded in the RAM 44 being executed by the CPU 42.

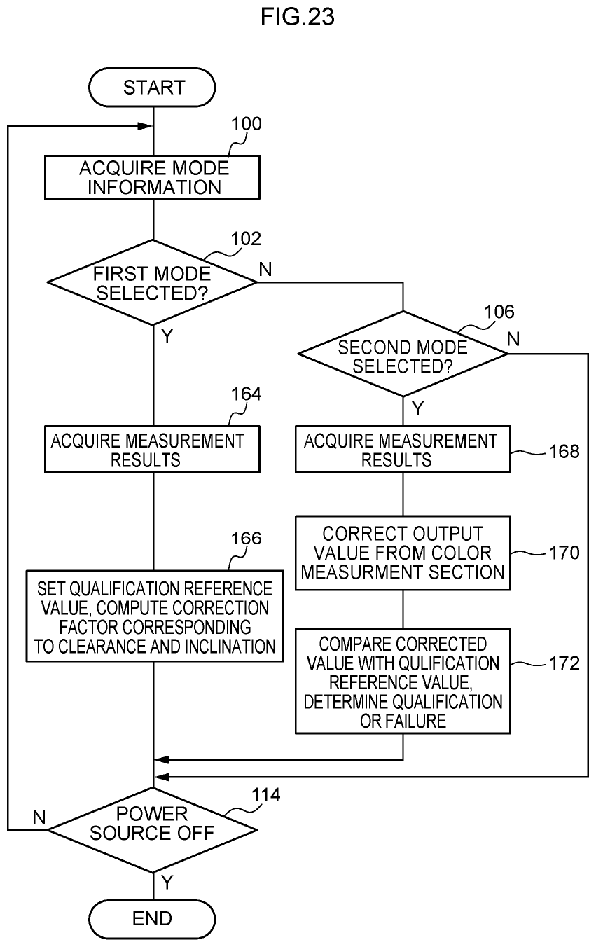

Next, an example of the flow of control processing, which is executed at the data processing section 272 (the data processing control device 280 (see FIG. 22)) at the evaluation device 270 shown in FIG. 21, is described as the operation of the present embodiment and with reference to the flowchart shown in FIG. 23.

As shown in FIG. 23, in the control processing of the present embodiment, instead of steps 154, 156 (see FIG. 20) of the control processing of the fifth embodiment, steps 164, 166 are set, and, instead of steps 158, 160, 162 (see FIG. 20) of the control processing of the fifth embodiment, steps 168, 170, 172 are set. Hereinafter, the portions that differ from the control processing of the fifth embodiment are described.

In step 164 that the routine moves on to in a case in which step 102 is affirmative, or in other words, in a case in which the first mode is selected, the data processing section 272 acquires the output values that are the results of measurement respectively output from the color measurement section 12, the first distance measurement portion 242 and the second distance measurement portion 244.

In step 166 after step 164, at the data processing section 272, the qualification reference setting section 74 sets the qualification reference value. In step 166, at the data processing section 272, after the distance inclination computing section 248 carries out the above-described predetermined computation, the correction factor computing section 274 computes a correction factor that corresponds to the average clearance that is the average value of the clearances La, Lb between the measurement target T2 and a predetermined region, which faces the measurement target side, at the color sensor 32B, and to the inclination of the direction 14X of the light illumination central axis of the light projecting portion 14 with respect to the direction orthogonal to the measurement target surface 62. To describe this further, before the correction factor computing section 274 computes the correction factor, the distance inclination computing section 248, from the output values that are respectively output from the first distance measurement portion 242 and the second distance measurement portion 244 in a state in which the first mode is selected, computes the average value of the clearances La, Lb between the measurement target T2 and a predetermined region, which faces the measurement target side, at the color sensor 32B, and computes the inclination of the direction 14X of the light illumination central axis of the light projecting portion 14 with respect to the direction orthogonal to the measurement target surface 62. Then, the correction factor computing section 274 computes the correction factor that corresponds to the above-described average clearance and the above-described inclination, based on the relationship between the output value, which is output from the color measurement section 12 in the state in which the first mode is selected, and the computed value, which is computed by the distance inclination computing section 248 based on the output values that are respectively output from the first distance measurement portion 242 and the second distance measurement portion 244 in the state in which the first mode is selected. The output value output from the color measurement section 12 and the computed value computed by the distance inclination computing section 248 are stored in association with one another. The routine moves on to step 114 after step 166.

Further, in step 168 that the routine moves on to in a case in which step 106 is affirmative, or in other words, in a case in which the second mode is selected, the data processing section 272 acquires the output values that are the results of measurement that are respectively output from the color measurement section 12, the first distance measurement portion 242 and the second distance measurement portion 244 in the state in which the second mode is selected. In step 170 after step 168, the data processing section 272 corrects the output value, which is output from the color measurement section 12 in second mode. To describe this more concretely, first, from the output values that are respectively output from the first distance measurement portion 242 and the second distance measurement portion 244, the distance inclination computing section 248 computes the average value of the clearances La, Lb between the measurement target T2 and a predetermined region, which faces the measurement target side, at the color sensor 32B, and computes the inclination of the direction 14X of the light illumination central axis of the light projecting portion 14 with respect to the direction orthogonal to the measurement target surface 62. Then, the determination section 276 corrects the output value output from the color measurement section 12 by the correction factor. The correction factor corresponds to the computed value computed by the distance inclination computing section 248 based on the output values respectively output from the first distance measurement portion 242 and the second distance measurement portion 244 in the state in which the second mode is selected.

In step 172 after step 170, the determination section 276 compares the corrected value determined in step 170 (in other words, the corrected value obtained by correcting the output value, which is output from the color measurement section 12, in accordance with the measurement conditions at the time of measurement thereof and based on a predetermined criterion) with the qualification reference value, and determines the qualification/failure. The routine moves on to step 114 after step 172.

Note that, if the evaluation device 270 that is shown in FIG. 21 is used, a method of evaluating a surface state of an inspection target can be implemented in the same way as in the fifth embodiment.

In accordance with the structure of the above-described present embodiment as well, because a determination on qualification/failure can be carried out without contacting the inspection target, the present embodiment can be applied to a high-speed production line. Further, in the present embodiment, in the same way as in the fifth embodiment, qualification/failure can be determined accurately even if there is dispersion in both of or one of the clearance between the light projecting portion 14 and the measurement point on the surface of the inspection target, and the inclination of the direction 14X of the light illumination central axis of the light projecting portion 14.

[Supplementary Explanation of Embodiments]

In the above-described first embodiment, third embodiment and fifth embodiment, the qualification reference setting section 26 that is shown in FIG. 1, FIG. 10 and FIG. 17 sets the qualification reference value differently for a case in which the data of the output value output from the color measurement section 12 in the state in which the first mode is selected is one data within a per-design-specification category that has been classified by information on the design specifications of the measurement target, and for a case in which the data is plural data. However, for example, in a case that is premised on the number of products (qualified articles) per design specification, which are measured by the color measurement section 12 in a state in which the first mode is selected, always being one, there is no need to provide a logic that assumes a case in which the number of products (qualified articles) per design specification is a plural number. Further, in a case that is premised on the number of products (qualified articles) per design specification, which are measured by the color measurement section 12 in the state in which the first mode is selected, always being a plural number, there is no need to provide a logic that assumes a case in which the number of products (qualified articles) per design specification is one.

Further, in the above-described second embodiment, fourth embodiment and sixth embodiment, the qualification reference setting section 26 that is shown in FIG. 7, FIG. 14 and FIG. 21 sets the qualification reference value differently for a case in which the data of the output value output from the color measurement section 12 in the state in which the first mode is one data, and for a case in which the data is plural data. However, for example, in a case that is premised on the number of products (qualified articles), which are measured by the color measurement section 12 in a state in which the first mode is selected, always being one, there is no need to provide a logic that assumes a case in which the number of products (qualified articles) is a plural number. Further, in a case that is premised on the number of products (qualified articles), which are measured by the color measurement section 12 in the state in which the first mode is selected, always being a plural number, there is no need to provide a logic that assumes a case in which the number of products (qualified articles) is one.

Further, in the above-described first embodiment, the data processing section 24 shown in FIG. 1 stores, in a table and in association with one another, the input information that specifies the design specifications of the product and that is used in setting the qualification reference value, and the qualification reference value that is set by the qualification reference setting section 26, and the determination section 28 determines the qualification/failure by referring to this table. Such a structure is preferable from the standpoint of efficiently (speedily) determining the qualification/failure, and a similar structure can be applied in the above-described third embodiment and fifth embodiment as well. However, a structure can also be employed in which, for example, the data processing section does not have the above-described table, and has a database in which output values, which are output from the color measurement section (12) in the state in which the first mode is selected, and information from the information input portion (20), are made to correspond to one another, and, at the time when the determination section (28) determines the qualification/failure, the qualification reference setting section refers to this database and sets the qualification reference value, and the determination section (28) determines the qualification/failure by using this qualification reference value as a reference.

Further, the data processing control programs 48, 78, 214, 234, 264, 284 that are shown in FIG. 2, FIG. 8, FIG. 11, FIG. 15, FIG. 18, FIG. 22 may be stored on a storage medium or the like and made able to be distributed.

Further, in the above-described first through sixth embodiments, the evaluation devices 10, 70, 200, 220, 240, 270 that are shown in FIG. 1, FIG. 7, FIG. 10, FIG. 14, FIG. 17, FIG. 21 are devices that assume that, after the first mode is selected at the mode selection unit 22 and the surface state of a qualified article is measured, the second mode is selected at the mode selection unit 22. Therefore, the flow of the control processing in a case in which the second mode is selected before the qualification reference value is set is omitted. However, for example, a step in which, before the qualification reference value is set, an error message is displayed on the output portion (30) in a case in which the second mode is selected and a judgment on qualification/failure cannot be carried out, may be added to the flow of the control processing. Similarly, in the above-described third through sixth embodiments, the flow of control processing in a case in which the second mode is selected before the correction factor is computed is omitted. However, for example, a step in which an error message is displayed on the output portion (30) in a case in which the second mode is selected before the correction factor is computed and a judgment on qualification/failure cannot be carried out, may be added to the flow of the control processing.

Moreover, the above-described embodiments describe cases of application to the evaluating of the surface state after the removal of rust or scale by shot blasting. However, for example, the present disclosure may be applied to the evaluating of the surface state after the removal of rust or scale by laser cleaning or the like, or may be applied to the evaluating of the surface state after paint removal or after peeling-off of coating by shot blasting or the like.

In addition to the above, the present disclosure can, of course, be implemented by being modified in various ways that does not depart from the scope of the present disclosure.

Note that the disclosure of Japanese Patent Application No. 2017-219029 is, in its entirety, incorporated by reference into the present specification.

1. A method for evaluating a surface state of an inspection target by using a color sensor, the color sensor having a light projecting portion and a light receiving portion, the color sensor being configured such that light is illuminated from the light projecting portion, is reflected at an inspection target surface, and is received at the light receiving portion, and the color sensor computing an output value corresponding to a color of the inspection target from light intensities of red, blue and green that are received at the light receiving portion, the method comprising:
measuring, in advance and by the color sensor, one point on a surface of a qualified article without contacting the surface, and, based on the output value from the color sensor, setting, by a computer, a qualification reference value;
thereafter, measuring, by the color sensor without contact, one point on a surface of an inspection target having the same design specifications as the qualified article;
after the qualification reference value is set, comparing, by the computer, the output value of the inspection target, or a corrected value, with the qualification reference value, the output value of the inspection target being output from the color sensor, and the corrected value being obtained by correcting the output value of the inspection target in accordance with measuring conditions at a time of measurement by the color sensor and based on a predetermined criterion; and
determining qualification or failure of the inspection target.

2. The method of claim 1, wherein:
before one point on the surface of the inspection target is measured by the color sensor, one point on the surface of the qualified article is measured by the color sensor in a plurality of patterns each having a different clearance, along a direction of a light illumination central axis of the light projecting portion, between the surface of the qualified article and a predetermined region of the color sensor facing a measurement target side, and the clearance is measured by a distance measurement meter that is built into the color sensor,
the computer computes a correction factor, which corresponds to the respective clearances, based on a relationship between output values from the distance measurement meter and output values relating to color from the color sensor, in the plurality of patterns,
thereafter, a clearance, along a direction of the light illumination central axis of the light projecting portion, between the surface of the inspection target and a predetermined region of the color sensor facing the measurement target side, the color sensor being disposed at a position for measuring the inspection target, is measured by the distance measurement meter without contacting the inspection target, and
the computer corrects an output value, which relates to the color at a time when one point on the surface of the inspection target is measured without contact by the color sensor, by the correction factor, which corresponds to a value measured by the distance measurement meter after the correction factor is computed, compares the corrected value with the qualification reference value, and determines qualification or failure of the inspection target.

3. The method of claim 1, wherein:
before one point on the surface of the inspection target is measured by the color sensor, one point on the surface of the qualified article is measured by the color sensor in a plurality of patterns each having different conditions, the conditions comprising a clearance, along a direction of a light illumination central axis of the light projecting portion, between the surface of the qualified article and a predetermined region of the color sensor facing a measurement target side, and an inclination of the direction of the light illumination central axis of the light projecting portion with respect to a direction orthogonal to a measured portion of the surface of the qualified article, and the clearance is respectively measured by two distance measurement meters that are built into the color sensor at respective sides in a direction in which the light projecting portion and the light receiving portion are aligned,
the computer computes the inclination and an average value of the clearance as first data from results of measurement by the two distance measurement meters, and computes in advance a correction factor that corresponds to the inclination and to the average clearance based on a relationship between the first data, and output values relating to color from the color sensor, in the plurality of patterns,
thereafter, a clearance, along the direction of the light illumination central axis of the light projecting portion, between the surface of the inspection target and a predetermined region of the color sensor facing the measurement target side, the color sensor being disposed at a position for measuring the inspection target, is respectively measured by the two distance measurement meters without contacting the inspection target,
the computer computes an average value of the clearances, and an inclination of the direction of the light illumination central axis of the light projecting portion with respect to a direction orthogonal to the measured portion of the surface of the inspection target as second data, from the two results of measurement, and
the computer corrects an output value, which relates to the color at a time when one point on the surface of the inspection target is measured without contact by the color sensor, by the correction factor, which corresponds to the second data, compares the corrected value with the qualification reference value, and determines qualification or failure of the inspection target.

4. The method of claim 1, wherein one point on a surface of one qualified article having the same design specifications as the inspection target is measured in advance by the color sensor, and the computer sets the output value of the one qualified article as the qualification reference value.

5. The method of claim 1, wherein respective single points on surfaces of a plurality of qualified articles having the same design specifications as the inspection target are measured in advance by the color sensor, and the computer sets a lowest output value among the output values of the plurality of qualified articles as the qualification reference value.

6. An evaluation device that evaluates a surface state of an inspection target that is a product having specific design specifications, the evaluation device comprising:
a color measurement section having a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement;
a mode selection unit configured to select a first mode in a case of measuring a surface state of a qualified article having the specific design specifications, and a second mode in a case of determining a surface state of an inspection target; and
a data processing section having:
a qualification criteria setting section, which sets a qualification reference value based on the output value that is output from the color measurement section in a state in which the first mode is selected, and
a determination section that compares the output value, or a corrected value, with the qualification reference value, the output value being output from the color measurement section in a state in which the second mode is selected, and the corrected value being obtained by correcting the output value in accordance with measurement conditions at a time of measurement by the color measurement section and based on a predetermined criterion, and that determines qualification or failure of the inspection target.

7. The evaluation device of claim 6, further comprising a distance measurement portion that is integrated with the color measurement section to configure a measurement instrument, the distance measurement portion measuring, without contacting the measurement target, a clearance, along a direction of a light illumination central axis of the light projecting portion, between the measurement target and a predetermined region of the measurement instrument facing a measurement target side, wherein:
the data processing section has a correction factor computing section that computes a correction factor in accordance with the clearance based on a relationship between the output value that is output from the color measurement section in a state in which the first mode is selected, and an output value that is output from the distance measurement portion in a state in which the first mode is selected, the output value of the color measurement section and the output value of the distance measurement portion being stored in association with one another, and
the determination section corrects the output value that is output from the color measurement section in a state in which the second mode is selected, by the correction factor, which corresponds to an output value that is output from the distance measurement portion in a state in which the second mode is selected, and compares the corrected value with the qualification reference value, and determines qualification or failure of the inspection target.

8. The evaluation device of claim 6, further comprising two distance measurement portions that are disposed at respective sides of the color measurement section in a direction in which the light projecting portion and the light receiving portion are aligned, the two distance measurement portions being integrated with the color measurement section to configure a measurement instrument, and the two distance measurement portions respectively measuring, without contacting the measurement target, a clearance, along a direction of a light illumination central axis of the light projecting portion, between the measurement target and a predetermined region of the measurement instrument facing the measurement target side, wherein:
the data processing section comprises:
a distance inclination computing section that, based on output values respectively output from the two distance measurement portions, computes an average value of the clearance, and computes an inclination of the direction of the light illumination central axis of the light projecting portion with respect to a direction orthogonal to the measurement target surface; and
a correction factor computing section that computes a correction factor that corresponds to the inclination and to the average clearance, based on a relationship between an output value that is output from the color measurement section in a state in which the first mode is selected, and a computed value that is computed by the distance inclination computing section based on output values that are respectively output from the two distance measurement portions in a state in which the first mode is selected, the output value output from the color measurement section and the computed value computed by the distance inclination computing section being stored in association with one another, and
the determination section corrects the output value that is output from the color measurement section in a state in which the second mode is selected, by the correction factor, which corresponds to a computed value computed by the distance inclination computing section based on output values that are respectively output from the two distance measurement portions in a state in which the second mode is selected, and compares the corrected value with the qualification reference value, and determines qualification or failure of the inspection target.

9. The evaluation device of claim 6, wherein, in a case in which data of the output value that is output from the color measurement section in a state in which the first mode is selected comprises a single item of data, the qualification criteria setting section sets the output value as the qualification reference value.

10. The evaluation device of claim 6, wherein, in a case in which data of the output value that is output from the color measurement section in a state in which the first mode is selected comprises a plurality of items of data, the qualification criteria setting section sets a lowest value of the output values as the qualification reference value.

11. An evaluation device, comprising:
a color measurement section having a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement;
an information input portion configured for inputting information related to design specifications of a measurement target;
a mode selection unit configured to select a first mode in a case of measuring a surface state of a qualified article, and a second mode in a case of determining a surface state of an inspection target; and
a data processing section having:
a qualification criteria setting section that sets a qualification reference value for each design specification of the measurement target based on information from the information input portion and an output value that is output from the color measurement section in a state in which the first mode is selected, and
a determination section that compares the output value, or a corrected value, with the qualification reference value for a qualified article having the same design specifications as the measurement target, the output value being output from the color measurement section in a state in which the second mode is selected, and the corrected value being obtained by correcting the output value in accordance with measurement conditions at a time of measurement of the measurement target and based on a predetermined criterion, and that determines qualification or failure of the inspection target.

12. The evaluation device of claim 11, further comprising a distance measurement portion that is integrated with the color measurement section to configure a measurement instrument, the distance measurement portion measuring, without contacting the measurement target, a clearance, along a direction of a light illumination central axis of the light projecting portion, between the measurement target and a predetermined region of the measurement instrument facing a measurement target side, wherein:
the data processing section has a correction factor computing section that computes a correction factor, which corresponds to the clearance for each design specification of the measurement target, based on information from the information input portion and a relationship between the output value that is output from the color measurement section in a state in which the first mode is selected, and an output value that is output from the distance measurement portion in a state in which the first mode is selected, the output value output from the color measurement section and the output value output from the distance measurement portion being stored in association with one another, and
the determination section corrects the output value that is output from the color measurement section in a state in which the second mode is selected, by the correction factor, which corresponds to an output value that is output from the distance measurement portion in a state in which the second mode is selected, and to the information on the design specifications of the measurement target, and compares the corrected value with the qualification reference value for a qualified article having the same design specifications as the measurement target, and determines qualification or failure of the inspection target.

13. The evaluation device of claim 11, further comprising two distance measurement portions that are disposed at respective sides of the color measurement section in a direction in which the light projecting portion and the light receiving portion are aligned, the two distance measurement portions being integrated with the color measurement section to configure a measurement instrument, and the two distance measurement portions respectively measuring, without contacting the measurement target, a clearance, along a direction of a light illumination central axis of the light projecting portion, between the measurement target and a predetermined region of the measurement instrument facing the measurement target side, wherein:
the data processing section comprises:
a distance inclination computing section that, based on output values respectively output from the two distance measurement portions, computes an average value of the clearance, and computes an inclination of the direction of the light illumination central axis of the light projecting portion with respect to a direction orthogonal to the measurement target surface; and
a correction factor computing section that computes a correction factor that corresponds to the inclination and to an average clearance of the clearance for each design specification of the measurement target, based on information from the information input portion and a relationship between an output value that is output from the color measurement section in a state in which the first mode is selected, and a computed value that is computed by the distance inclination computing section based on output values that are respectively output from the two distance measurement portions in a state in which the first mode is selected, the output value output from the color measurement section and the computed value computed by the distance inclination computing section being stored in association with one another, and
the determination section corrects the output value that is output from the color measurement section in a state in which the second mode is selected, by the correction factor, which corresponds to the information on the design specifications of the measurement target and to a computed value computed by the distance inclination computing section based on output values that are respectively output from the two distance measurement portions in a state in which the second mode is selected, and compares the corrected value with the qualification reference value for a qualified article having the same design specifications as the measurement target, and determines qualification or failure of the inspection target.

14. The evaluation device of claim 11, wherein, in a case in which data of an output value that is output from the color measurement section in a state in which the first mode is selected comprises a single item of data within a per-design-specification category that has been classified based on the information on the design specifications of the measurement target, the qualification criteria setting section sets the output value as the qualification reference value for a product having the design specifications.

15. The evaluation device of claim 11, wherein, in a case in which data of an output value that is output from the color measurement section in a state in which the first mode is selected comprises a plurality of items of data within a per-design-specification category that has been classified based on the information on the design specifications of the measurement target, the qualification criteria setting section sets a lowest value of the output values as the qualification reference value for a product having the design specifications.

16. The evaluation device of claim 11, wherein the data processing section stores the input information, which specifies the design specifications of the qualified article and which is used in setting the qualification reference value, and stores the qualification reference value, which is set by the qualification criteria setting section, in a table in association with one another, and the determination section determines qualification or failure with reference to the table.

17. A method of controlling an evaluation device that evaluates a surface state of an inspection target that is a product having specific design specifications, the evaluation device comprising:
a color measurement section that has a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement; and
a mode selection unit configured to select a first mode in a case of measuring a surface state of a qualified article having the specific design specifications, and a second mode in a case of determining a surface state of an inspection target, the method comprising:
in a case in which the first mode is selected, setting a qualification reference value based on an output value that is output from the color measurement section;
in a case in which the second mode is selected, comparing an output value, or a corrected value, with the qualification reference value, the output value being output from the color measurement section in a state in which the second mode is selected, and the corrected value being obtained by correcting the output value in accordance with measurement conditions at a time of measurement in the second mode and based on a predetermined criterion; and
determining qualification or failure of the inspection target.

18. A method of controlling an evaluation device, the evaluation device comprising:
a color measurement section that has a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement;
an information input portion configured for inputting information related to design specifications of the measurement target; and
a mode selection unit configured to select a first mode in a case of measuring a surface state of a qualified article, and a second mode in a case of determining a surface state of an inspection target, the method comprising:
in a case in which the first mode is selected, setting a qualification reference value for each design specification of the measurement target based on an output value that is output from the color measurement section and the information from the information input portion;
in a case in which the second mode is selected, comparing an output value, or a corrected value, with the qualification reference value for a product having the same design specifications as the measurement target, the output value being output from the color measurement section in a state in which the second mode is selected, and the corrected value being obtained by correcting the output value in accordance with measurement conditions at a time of measurement in the second mode and based on a predetermined criterion; and
determining qualification or failure of the inspection target.

19. A non-transitory recording medium storing a control program for an evaluation device that evaluates a surface state of an inspection target that is a product having specific design specifications, the evaluation device comprising:
a color measurement section that has a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement; and
a mode selection unit configured to select a first mode in a case of measuring a surface state of a qualified article having the specific design specifications, and a second mode in a case of determining a surface state of an inspection target, the control program causing a computer included in the evaluation device to execute processing comprising:
in a case in which the first mode is selected, setting a qualification reference value based on an output value that is output from the color measurement section;
in a case in which the second mode is selected, comparing an output value, or a corrected value, with the qualification reference value, the output value being output from the color measurement section in a state in which the second mode is selected, and the corrected value being obtained by correcting the output value in accordance with measurement conditions at a time of measurement in the second mode and based on a predetermined criterion; and
determining qualification or failure of the inspection target.

20. A non-transitory recording medium storing a control program for an evaluation device, the evaluation device comprising:
a color measurement section that has a light projecting portion that illuminates a measurement target surface, a light receiving portion that receives light from the light projecting portion that is reflected by the measurement target surface, and a computing section that computes an output value corresponding to a color of a measurement target from light intensities of red, blue and green received at the light receiving portion, wherein the color measurement section does not contact the measurement target at a time of measurement;
an information input portion configured for inputting information related to design specifications of the measurement target; and
a mode selection unit configured to select a first mode in a case of measuring a surface state of a qualified article, and a second mode in a case of determining a surface state of an inspection target,
the control program causing a computer included in the evaluation device to execute processing comprising:
in a case in which the first mode is selected, setting a qualification reference value for each design specification of the measurement target based on an output value that is output from the color measurement section and the information from the information input portion;
in a case in which the second mode is selected, comparing an output value, or a corrected value, with the qualification reference value for a product having the same design specifications as the measurement target, the output value being output from the color measurement section in a state in which the second mode is selected, and the corrected value being obtained by correcting the output value in accordance with measurement conditions at a time of measurement in the second mode and based on a predetermined criterion; and
determining qualification or failure of the inspection target.
